(19) United States
(12) Patent Application Publication
(10) Pub. No.: US 2024/0292916 A1
(43) Pub. Date: Sep. 5, 2024

(54) Cup-Style Filtering Facepiece Respirator and Methods of Manufacture

(71) Applicant: NOVO TEXTILE COMANY LTD., Coquitlam (CA)

(72) Inventors: Jason Michael Zanatta, Coquitlam (CA); Julie Lim Zanatta, Coquitlam (CA)

(21) Appl. No.: 18/548,876

(22) PCT Filed: Mar. 4, 2022
(86) PCT No.: PCT/CA2022/050317

§ 371 Date: Sep. 1, 2023

Related U.S. Application Data
(60) Provisional application No. 63/157,125, filed on Mar. 5, 2021.

(51) Int. Cl. A41D 13/11; A62B 23/02

(52) U.S. Cl. CPC A41D 13/1146; A41D 13/1161; A62B 23/025

(57) ABSTRACT

A four-layer filtering facepiece respirator with a combination of hydrophilic and hydrophobic polypropylene non-woven fabrics of varying weights and weave. The filtering facepiece respirator includes an innermost layer which is formed into the shape of a cup and includes a combination of hydrophilic and hydrophobic layers. The filtering facepiece respirator also includes a nose piece and a strap.

### FIELD

Certain aspects of the present disclosure generally relate to a cup-style filtering facepiece respirator, such as an N95 or N99-compliant filtered facepiece respirator and methods of manufacture thereof.

### BACKGROUND

There are many N95- and/or N99-standard particulate filtering facepiece respirator on the market. These products have attracted considerable attention in view of certain public health events in recent years. It is desired to provide a cup-style filtered facepiece respirator which offers improved fit, comfort, and breathability over existing devices.

### SUMMARY

Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the present disclosure provides a four-layer filtered facepiece respirator which uses a combination of hydrophilic and hydrophobic fabrics to provide improved fit, comfort, and breathability over existing devices.

### BRIEF DESCRIPTION OF THE DRAWINGS

FIG. 1 illustrates four layers which may be used to form a filtering facepiece respirator according to one aspect of the present disclosure.

FIG. 2 illustrates an exemplary cup-molded inner cup of a filtering facepiece respirator according to one aspect of the present disclosure.

FIG. 3 illustrates an exemplary three-layer outer envelope of a filtering facepiece respirator according to one aspect of the present disclosure.

FIG. 4 illustrates another view of an exemplary three-layer outer envelope of a filtering facepiece respirator according to one aspect of the present disclosure.

FIG. 5 illustrates an exemplary four-layer filtering facepiece respirator according to one aspect of the present disclosure.

FIG. 6 illustrates an exemplary three-layer outer envelope of a filtering facepiece respirator according to one aspect of the present disclosure.

FIG. 7 illustrates another view of an exemplary four-layer filtering facepiece respirator according to one aspect of the present disclosure.

FIG. 8. illustrates a cross section of an exemplary four-layer filtering facepiece respirator according to another aspect of the present disclosure.

FIG. 9. illustrates an exemplary flowchart representing a method of manufacturing a four-layer filtering facepiece respirator according to one aspect of the present disclosure.

FIG. 10. illustrates an element of an exemplary apparatus for manufacturing an exemplary four-layer filtering facepiece respirator according to an aspect of the present disclosure.

FIGS. 11. to 60 illustrate elements of an apparatus for implementing an exemplary method manufacturing a four-layer filtering facepiece respirator according to an aspect of the present disclosure.

### DETAILED DESCRIPTION

Various aspects of the novel systems, apparatuses, and methods are described more fully hereinafter with reference to the accompanying drawings. The teachings disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus can be implemented, or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. Any aspect disclosed herein can be embodied by one or more elements of a claim.

Although aspects are described herein, many variations and permutations of these aspects fall within the scope of the disclosure. Although some benefits and advantages of the preferred aspects are mentioned, the scope of the disclosure is not intended to be limited to benefits, uses, or objectives. The detailed description and drawings are merely illustrative of the disclosure rather than limiting.

The disclosure includes a cup-style N95/N99 Filtered Facepiece Respirator (FFR).

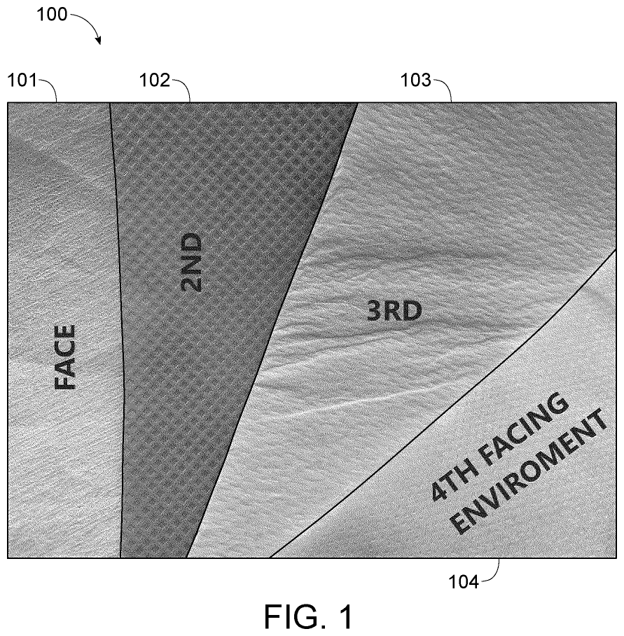

FIG. 1 is an illustration 100 of the four layers 101, 102, 103, 104 used in an exemplary a cup-style filtering facepiece respirator 100. The FFR can include four layers of non-woven polypropylene fabrics of varying weights and weave from manufacturing style. These layers have differing hydrophilic, hydrophobic, filtration, structural or shaping, non-sensitizing and breathability properties. The order in which these layers are described below should not be taken as limiting the order in which they are used to arrive at the claimed invention, as a person skilled in the art would readily recognize that the order of the layers could be modified without departing from the scope and nature of the invention.

A layer including hydrophilic properties may be a non-woven synthetic fabric layer such as a bicomponent hybrid polyester or polypropylene fabric layer selected for liquid absorption and air permeability. In some embodiments, a layer with hydrophilic properties may be a bicomponent polyester (PET)/polyamide (PA) hybrid mix fabric (Madaline® available from Mogul Co. Ltd.) having a weight of 100 g/m² and a thickness of 0.75 mm, for example. Other suitable materials for a layer with hydrophilic properties include cotton, polypropylene, linen, polyurethane, polyester, and polyamide. In embodiments, the layer including hydrophilic properties may comprise 20-35 gsm spunbond polyester of various percentages of polypropelene.

A layer including selected structural or shaping properties may be a non-woven synthetic fabric layer such as a bicomponent polyurethane fabric layer selected for structural strength, such as rigidity or elasticity. In some embodiments, the layer including selected structural or shaping properties may be a 5.9 OPSY PET/Bico Felt layer having a weight of 200 g/m² and a thickness of 1.19 mm, for example. In embodiments, the layer including selected structural or shaping properties may be 100-220 gsm cotton punch polypropelene, such as commonly known needle punch, felt, or bico-felt.

A layer including filtration properties may be a non-woven synthetic fabric layer such as a spunbond polypropylene fabric layer selected for breathability and permeability of particulates, bacteria, and air. In some embodiments, a layer with filtration properties may be a spunbond meltblown polypropylene fabric layer have a weight of 25 g/m² and a thickness of 0.20 mm, for example. In embodiments, the layer with filtration properties may comprise 20-40 gsm meltblown, including meltblown of various grades and quality with imprint shapes ranging from sesame shaped to diamond shaped.

A layer including hydrophobic properties may be a non-woven synthetic fabric layer such as a spunbond polypropylene fabric layer selected for fluid-resistance. In some embodiments, layer with hydrophobic properties may be a spunbond-meltblown-spunbond (SMS) polypropylene fabric layer having a weight of 60 g/m² and a thickness of 0.50 mm, for example. Other suitable materials for a layer with hydrophobic properties include polypropylene, linen, polyurethane, polyester, and polyamide. In embodiments, the layer including hydrophobic properties may comprise 20-35 gsm spunbond polyester of various percentages of polypropelene.

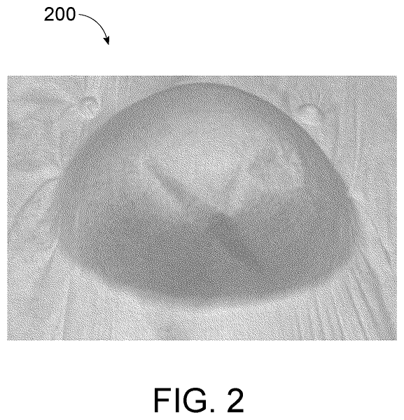

In embodiments, the innermost layer 101 may be fully molded into the shape of a cup 200, as illustrated in FIG. 2. The shape of cup 200 may be configured to fit over a user's nose and mouth and with edges that are configured to closely match the geometry of a user's face, following the contours of the user's cheeks, nose bridge, and chin to form a enclosing seal, while having a raised convex portion encapsulating the nose and mouth to prevent the fabric from interfering with the user's breathing. As used herein, the innermost layer 101 will be the layer with is closest to the face of a user of the filtering facepiece respirator 200. The innermost layer 101 may be formed using hybrid-mix fabric with microfilaments comprising PET/PA polymers provide a soft, breathable, strong, and smooth surface.

The fabric may have a dense structure which provides good barrier and filtration properties. The fabric may also have microfilaments, which allow it to be absorbent, quick to dry, breathable (good moisture management), and washable. The fabric may also exhibit good thermal insulation and wind resistance. For example, this has been measured as bacterial filtration-BFE 90.5%& PFE 98%@100 gsm (Nelson Lab, USA). The fabric may also be alcohol and blood repellent (with special treatment for Medical protective workwear). The fabric may also be economical for washable medical protective workwear.

The fabric's tactile and structural properties make it suitable as a PET/PA6 microfilament fabric. The fabric includes filaments which are 0.2 denier. This microfilament structure brings many unique properties to fabric including: Softness and comfort-microfilament structure, safe in contact with skin (even for an infant), OEKO-TEX Standard 100 certified, ECARF certified, breathable, lint-free, and having 3D shape memory-meeting common requirements for a surgical-use cup-shaped face mask.

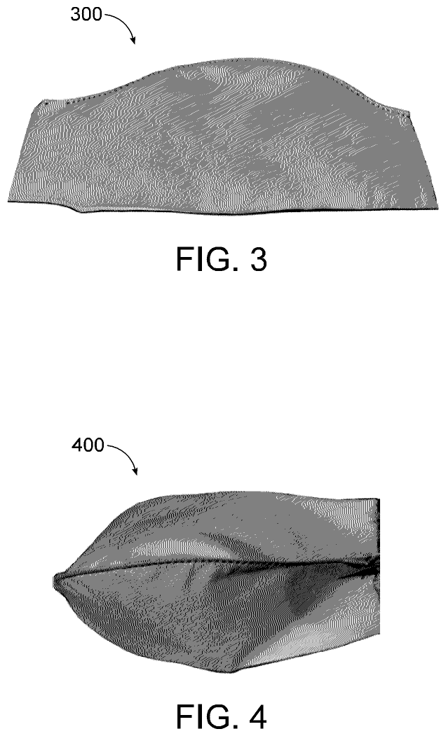

In embodiments, the top three layers 102, 103, 104 of the filtering facepiece respirator 100 may be placed together in a manner such that the three layers 102, 103, 104 are abutting so as they substantially overlap. In some embodiments, such as illustrated in FIGS. 3 & 4, and the exemplary embodiments described below, sonic welding may be used to attach one or more of the layers 102, 103, 104 to each other. Sonic welding involves selectively heating portions of the fabric layer through the localized application of high-frequency ultrasonic waves to melt and fuse the layers, avoiding the need for fasteners such as staples or clips. The use of staples or clips increases the risk of perforating the facemask, which would render the mask useless. Further, sonic welding creates strong connections between the welded fabrics, and between the welded fabric and straps. Therefore, sonic welding is a superior design choice. In other embodiments, heat molding, stitching, or other methods of attaching layers of non-woven synthetic fabric known in the art are contemplated. These three layers 102, 103, 104 may share a sonically welded seam in their center. These four layers, both the innermost layer 101 and the other three layers 102, 103, 104, may be selected from fabrics which have a combination of hydrophilic, hydrophobic, weight, weave, shaping, non-sensitizing and filtration properties. The outermost mask layer 104 fabric has the hydrophobic ability to repel moisture which helps prevent droplets from absorbing into the fabric. The innermost fabric layer 101 has the hydrophilic ability to absorb moisture therefore wicking it away from the face.

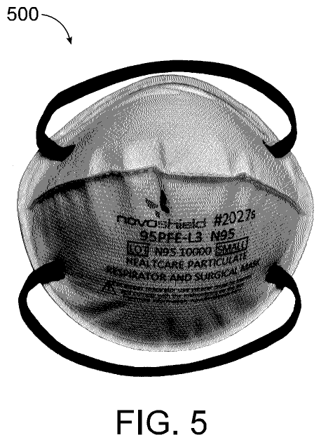

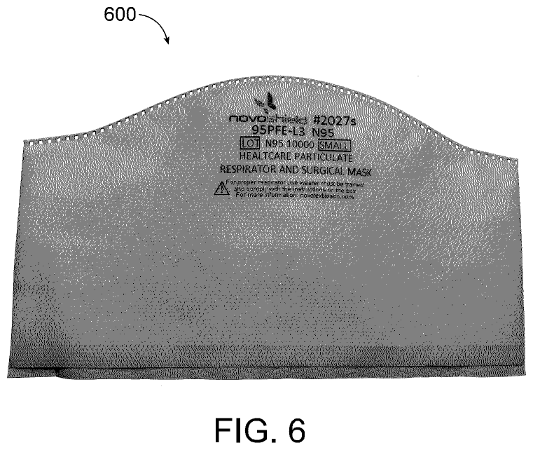

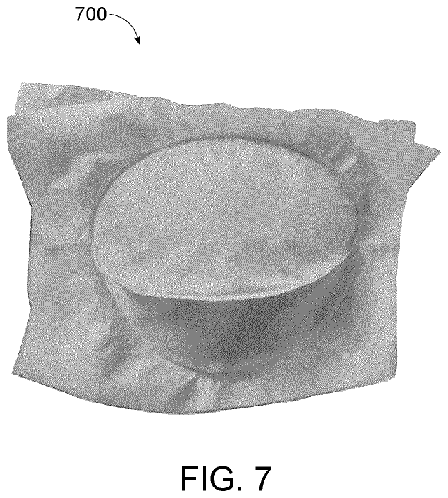

These layers may then be sonically welded to the formed cup 200 at the edges, as illustrated in FIG. 5.

In another embodiment of a cup-style filtering facepiece respirator 60, the filtering facepiece respirator includes four layers of non-woven polypropylene fabrics of varying weights and weave from manufacturing style. These layers have differing hydrophilic, hydrophobic, filtration, structural, shaping, non-sensitizing and breathability properties. These four layers may be selected from fabrics which have a combination of hydrophilic, hydrophobic, weight, weave, shaping, non-sensitizing and filtration properties, as well as for the behavior of the fabric when exposed to heat, as further described below for each layer.

The innermost layer 601, in one embodiment may be a hydrophilic contact layer, and may be a bicomponent hybrid polyester or polypropylene fabric layer with hydrophilic and non-sensitizing properties intended for contact with a user's face. Material for the innermost layer is selected on the basis of non-toxicity based on cytotoxicity tests, breathability, and comfort for the user. The innermost layer 601 has the hydrophilic ability to absorb moisture therefore wicking it away from the face. The innermost layer 601 may also provide filtration, such as bacterial filtration. In one embodiment, the innermost layer 601 may comprise a bicomponent polyester (PET)/polyamide (PA) hybrid mix fabric (Madaline® available from Mogul Co. Ltd.) having a weight of 100 g/m² and a thickness of 0.75 mm. In embodiments, the innermost layer 601 may comprise 20-35 gsm spunbond polyester of various percentages of polypropelene.

The second innermost layer 602, in one embodiment may be a shape layer, and may be a bicomponent polyurethane fabric layer, which may provide structural rigidity and elasticity, allowing the molded cup 600 to resist deformation and to return to its original shape during storage and use. The second innermost layer 602 is shaped to improve fitting to a user's face and to reduce pressure on the skin of the user to increase comfort over long-term use of the respirator. In one embodiment second innermost layer 602 may comprise a 5.9 OPSY PET/Bico Felt layer having a weight of 200 g/m² and a thickness of 1.19 mm. In embodiments, the second innermost layer 602 may comprise 100-220 gsm cotton punch polypropelene, such as commonly known needle punch, felt, or bico-felt.

The second outermost layer 603, in one embodiment may be a filter layer, and may be a spunbond polypropylene fabric layer for filtration, such as for particulate filtration and bacterial filtration. In one embodiment, the second outermost layer 603 may be a spunbond meltblown polypropylene fabric layer have a weight of 25 g/m² and a thickness of 0.20 mm. In embodiments, the second outermost layer 603 may comprise 20-40 gsm meltblown, including meltblown of various grades and quality with imprint shapes ranging from sesame shaped to diamond shaped.

The outermost layer 604, in one embodiment may be a hydrophobic layer, and may be a spunbond polypropylene fabric layer. The outermost layer 604 has the hydrophobic ability to repel moisture which helps prevent external droplets from absorbing into the fabric of the respirator. In one embodiment, the outermost layer 604 may be a spunbond-meltblown-spunbond (SMS) polypropylene fabric layer having a weight of 60 g/m² and a thickness of 0.50 mm. In embodiments, the outermost layer 604 may comprise 20-35 gsm spunbond polyester of various percentages of polypropelene.

The two innermost layers 601, 602 may comprise synthetic fabric layers molded into a molded cup 600, as illustrated in FIG. 2 by heat molding the layers together. The second innermost layer 602 may be heat-treated by one side of the mold to heat-treated optionally to between 110° C. and 130° C. preferably to between 115° C. and 120° C., and ideally to 117.5° C., for about 9 seconds. In addition, sufficient pressure is applied to deform the fabric. The application of both heat and pressure result in forming and strengthening the fabric while maintaining breathability. Applying higher temperatures or heating for longer periods results in an inner cup which is more brittle and rigid, which reduces the ability of the mask to conform to the user's face and thereby reduces the effectiveness of the mask. Applying lower temperatures or shorter periods of time results in the mask not acquiring and retaining a proper shape, which reduces the effectiveness of the mask. The innermost layer 601 may be heat treated to optionally between 30 and 35° C. and optimally to 32.5° C. by heat transferred from the one side of the mold through the second innermost layer 602. In another embodiment, the innermost layer may instead be heat treated by heat from a second side of the mold.

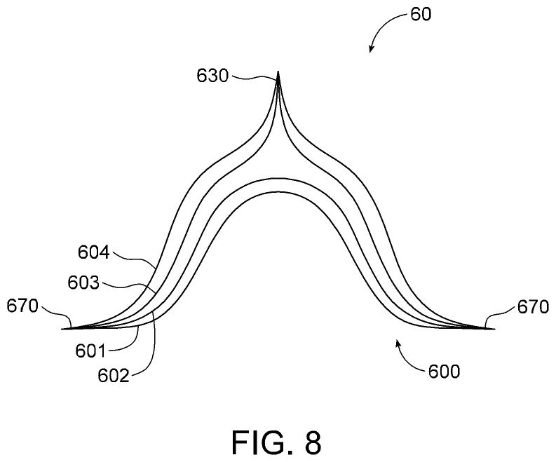

The two outermost layers 603, 604 may be attached together, for instance as illustrated in FIGS. 3 & 4, to join the layers 603, 604 to form an envelope in preparation for attaching the two layers 603, 604 of the envelope to the molded cup 600 formed by the two innermost layers 601, 602. In this exemplary embodiment, the two outermost layers 603, 604 may share a seam 630 in their center, allowing the two outermost layers 603, 604 to conform to the shape of the molded cup 600 when unfolded opposite the seam 630. The two outermost layers 603, 604 may then be sonically welded to the molded cup 600 at the edges 670, as illustrated in FIG. 8 to form the respirator 60. It should be understood that FIG. 8. depicts the respirator 60 schematically, and that the thickness and spacing between the layers 601, 602, 603, 604 are not to scale and may be exaggerated to more clearly depict the structural composition of the respirator 60.

In embodiments, the respirator 60 may include an inner edge adjacent to the seam 670 which does not substantially form part of the concavity of the formed cup, and which extends about at least a portion or plurality of portions of the circumference of the seam 670 of respirator 60. The inner edge adjacent to the seam 670 provides an additional contact surface for the respirator 60 to interface with the user's face, and therefore results in a better seal for the respirator 60. In embodiments, the inner edge adjacent to the seam 670 is located on opposite inner sides of the respirator 60.

The filtering facepiece respirator may further include a formed nose interfacing portion. In some embodiments, the nose interfacing portion may comprise a nose foam and an aluminum nose wire. The wire may have a hotmelt back. In other embodiments, the filtering facepiece respirator 100 may include only a nose wire and no foam. The nose wire may be sufficiently rigid to form a suitable seal with the nose, while being sufficiently light and flexible to retain comfort without the need of nose foam when the nose wire is shaped in combination with the innermost layer 601 of the respirator. In one embodiment, the nose wire may be a cylindrical aluminum having a diameter of between 0.5 mm to 0.6 mm. A strap for securing the respirator to the user's face, such as an elastic, may also be attached to the respirator 100 to allow a user to wear the respirator 100. For example, a black or dark red elastic may be used in one specific embodiment.

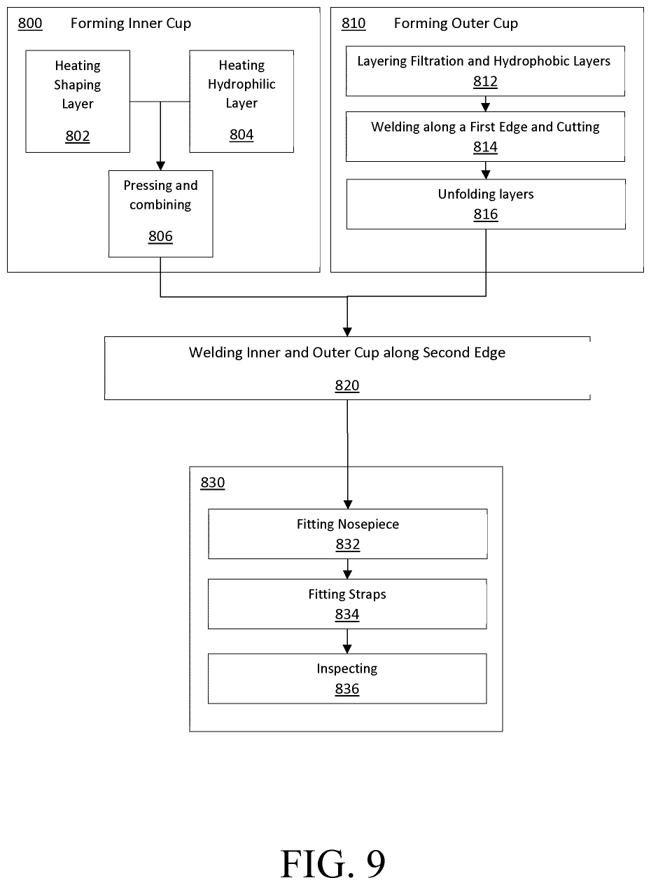

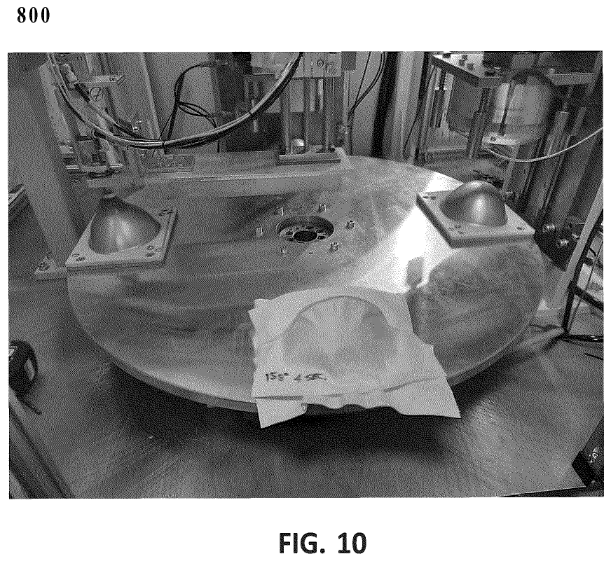

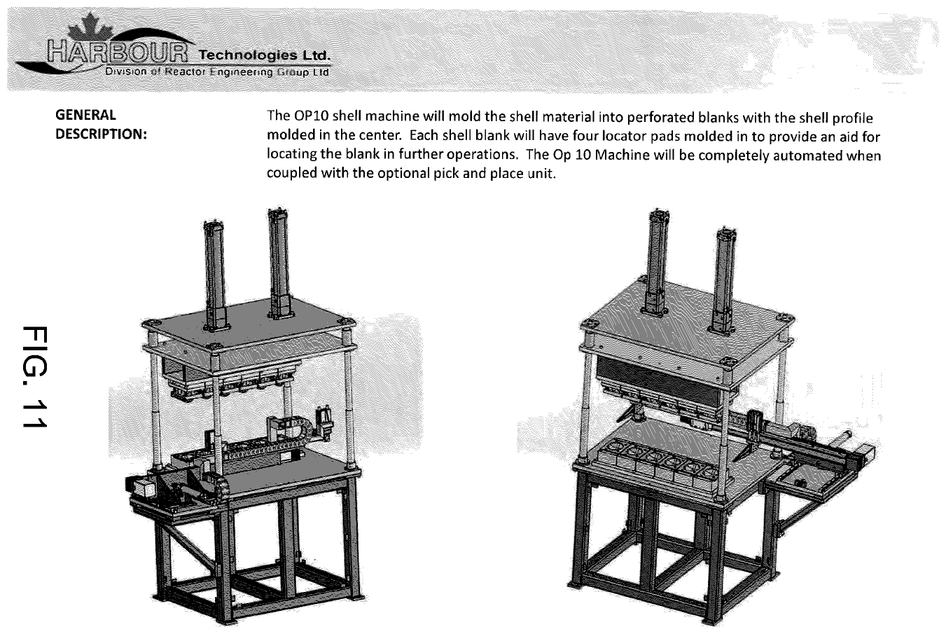

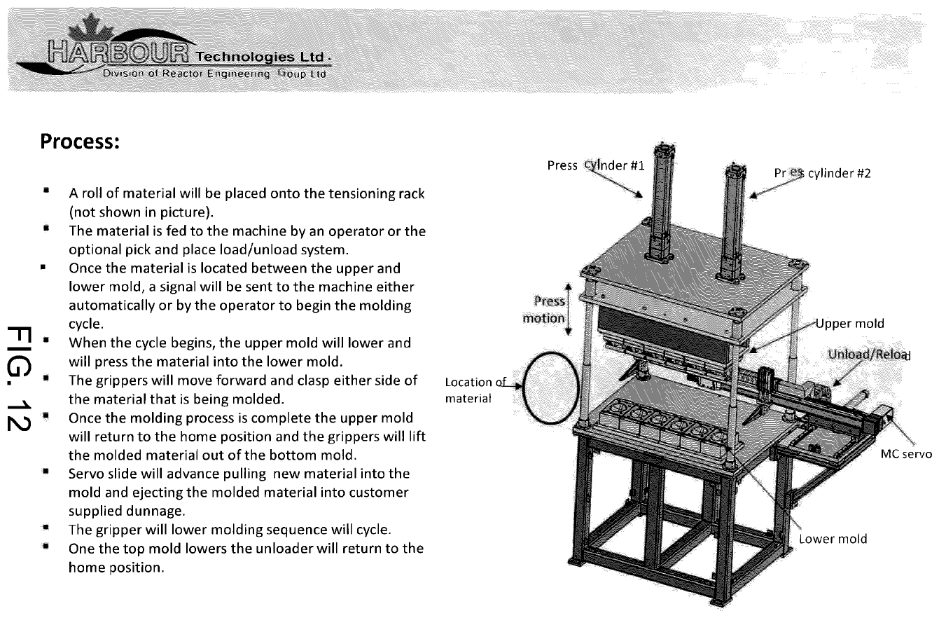

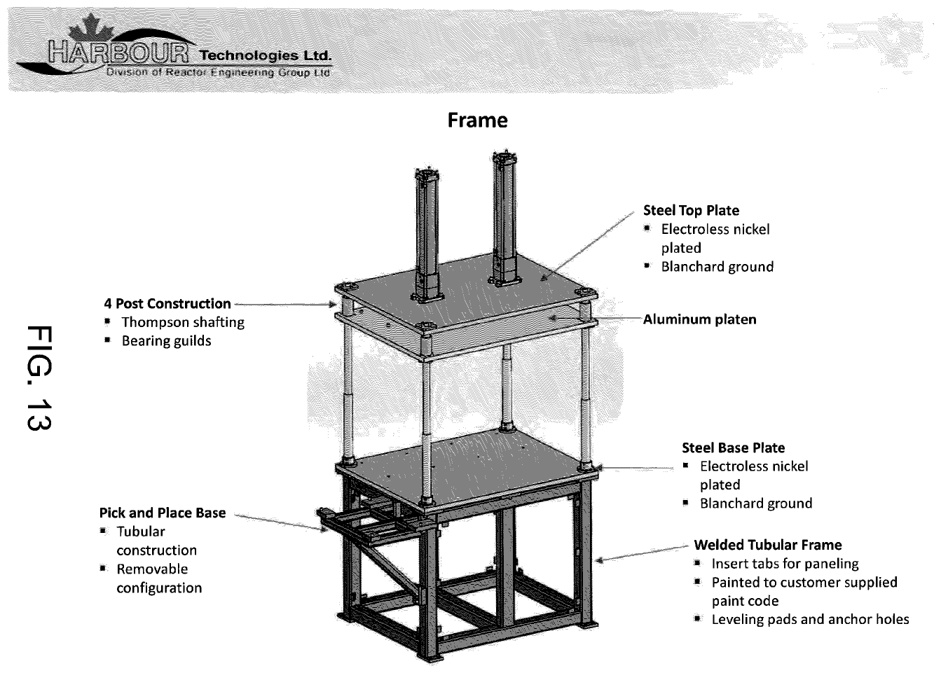

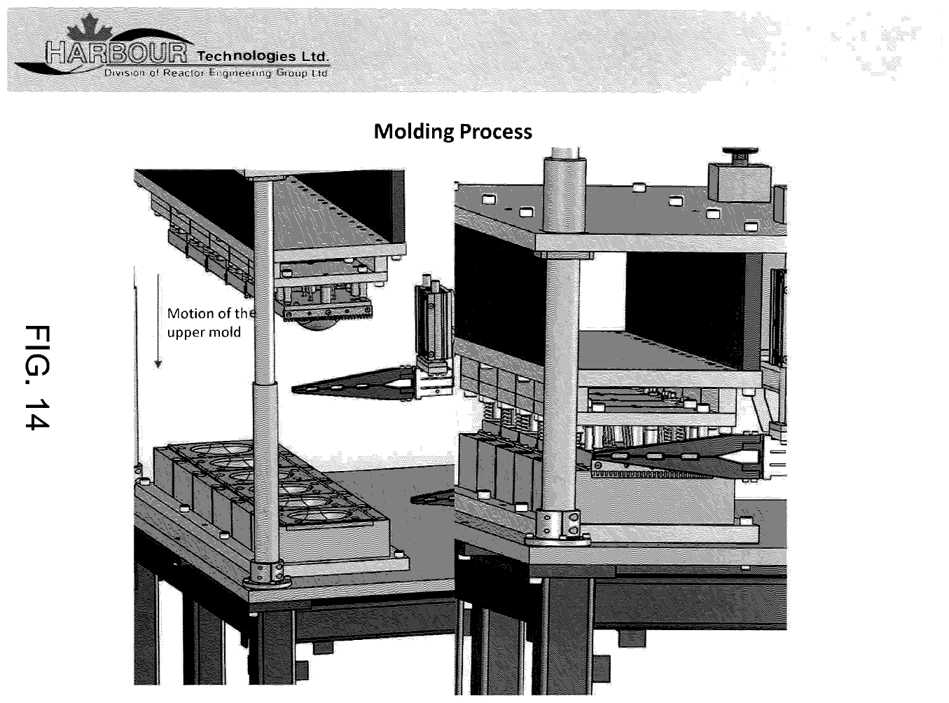

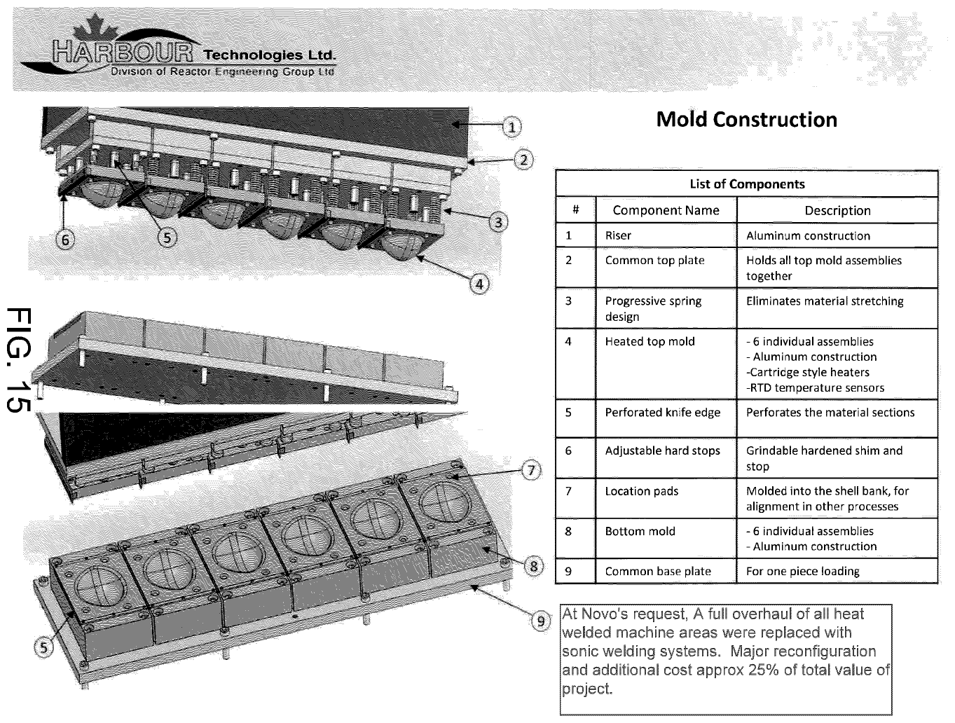

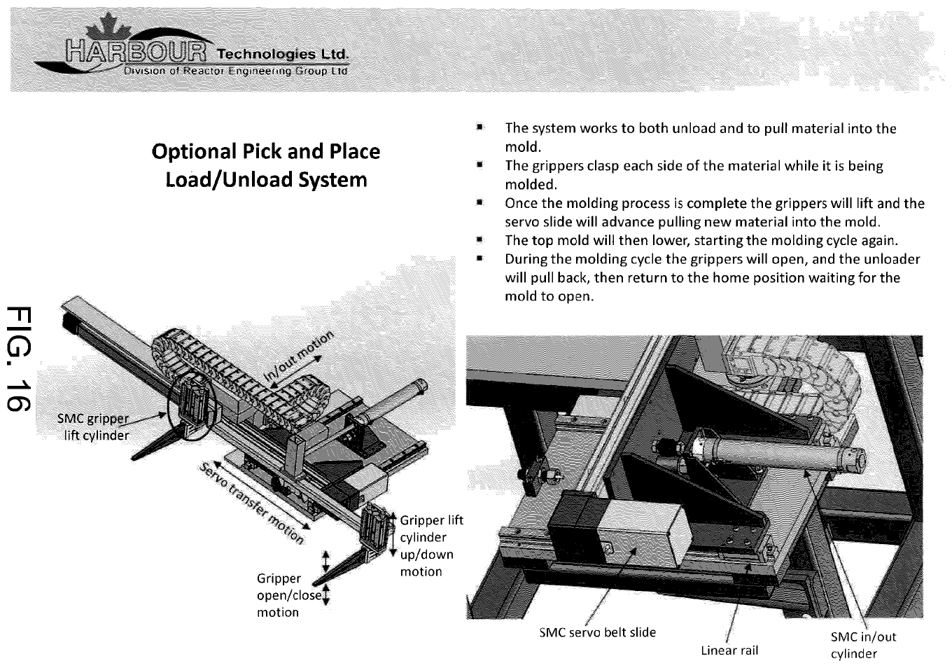

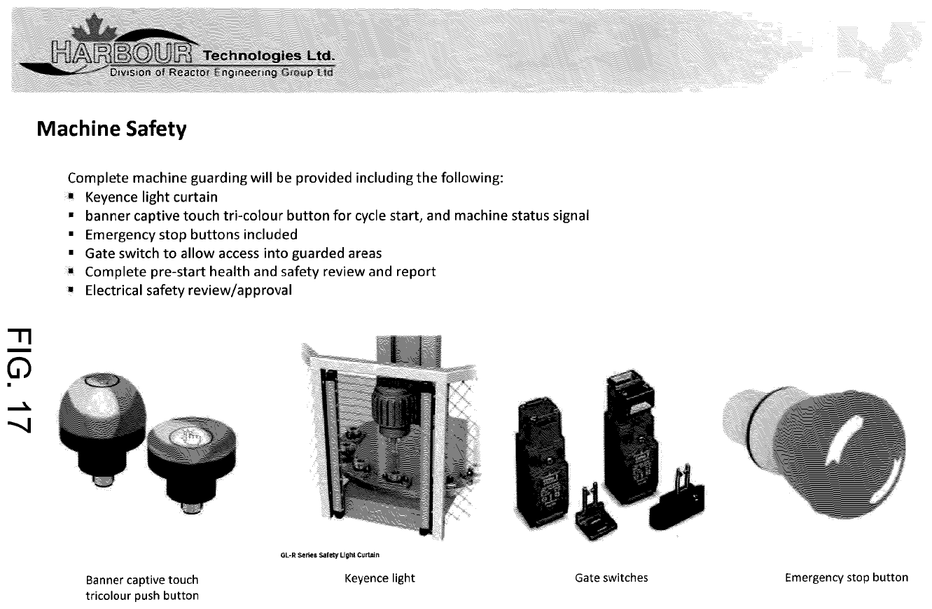

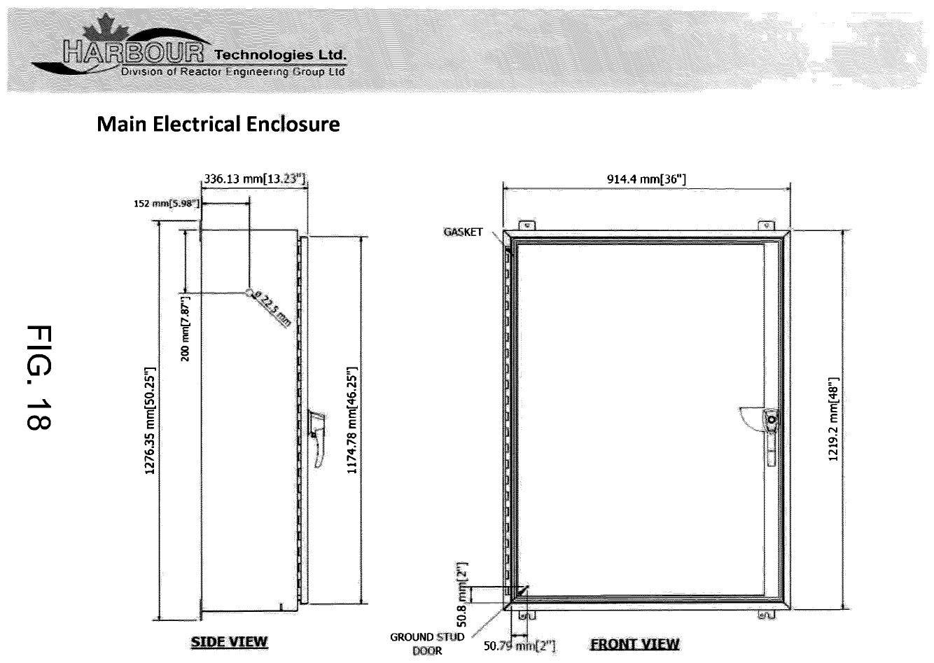

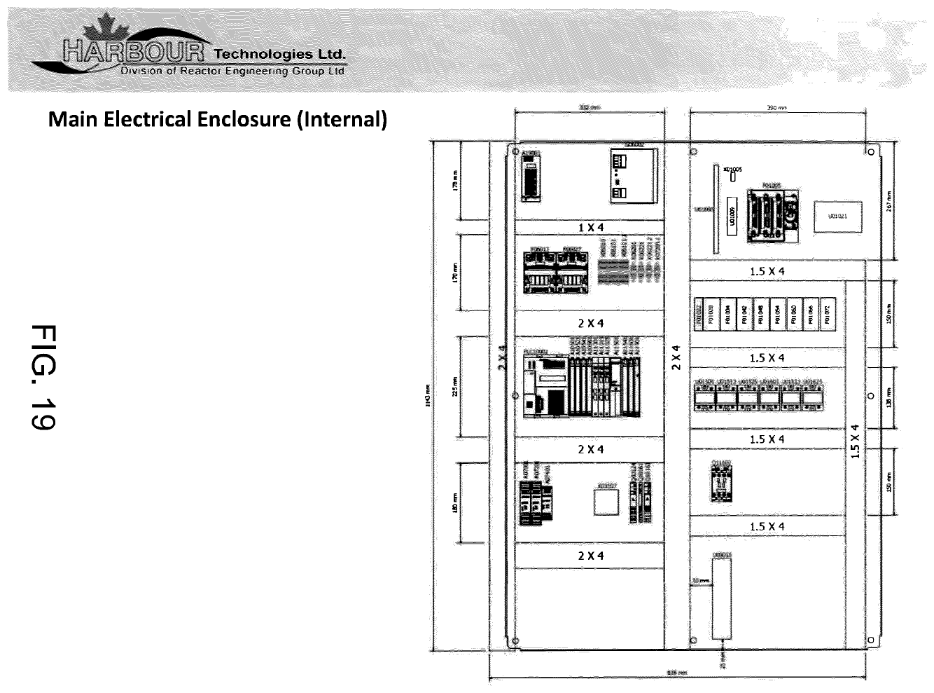

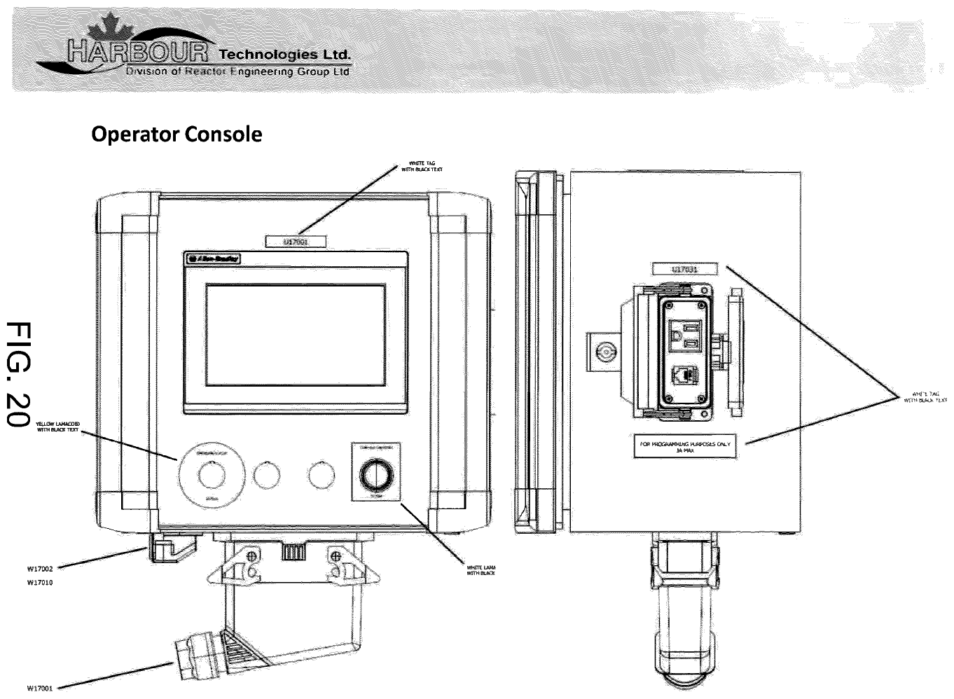

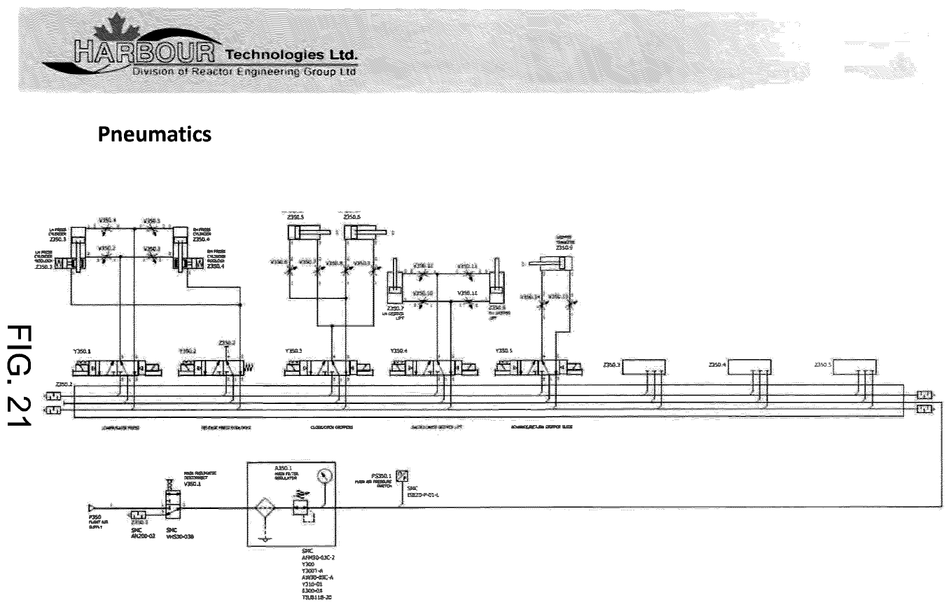

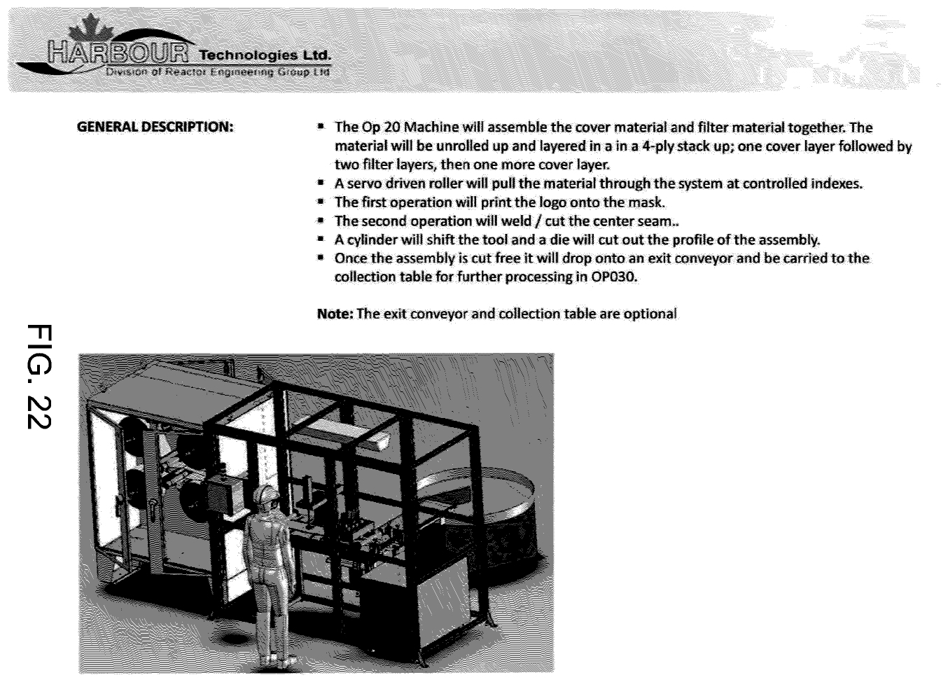

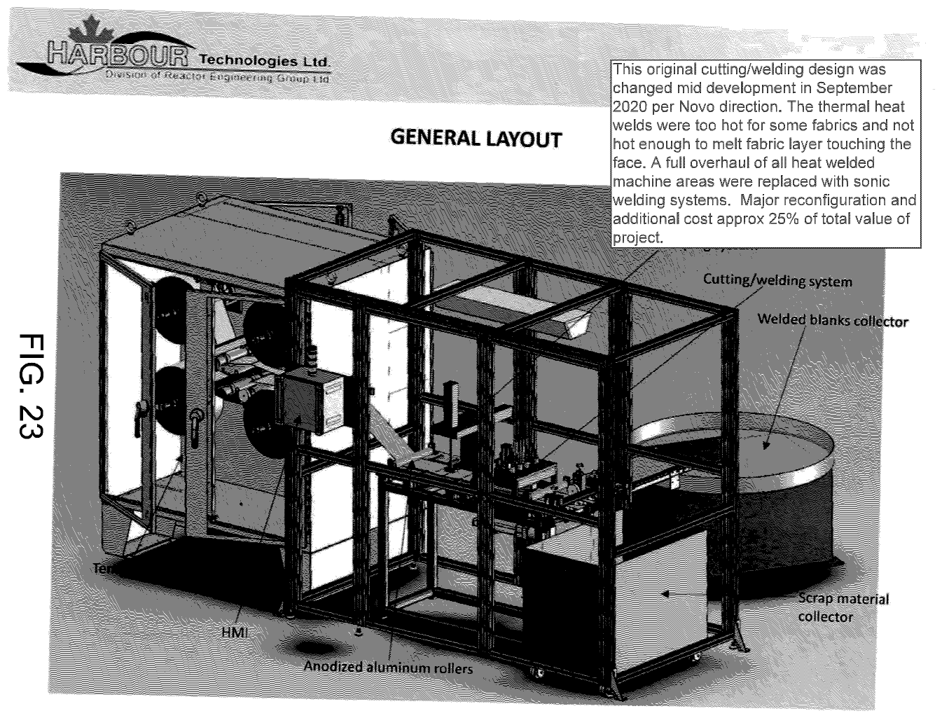

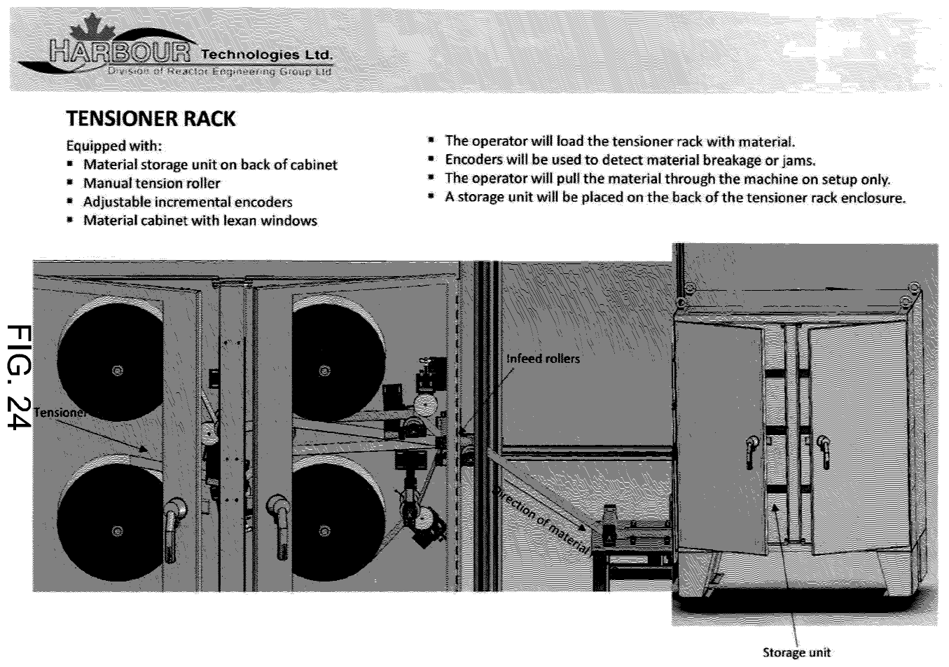

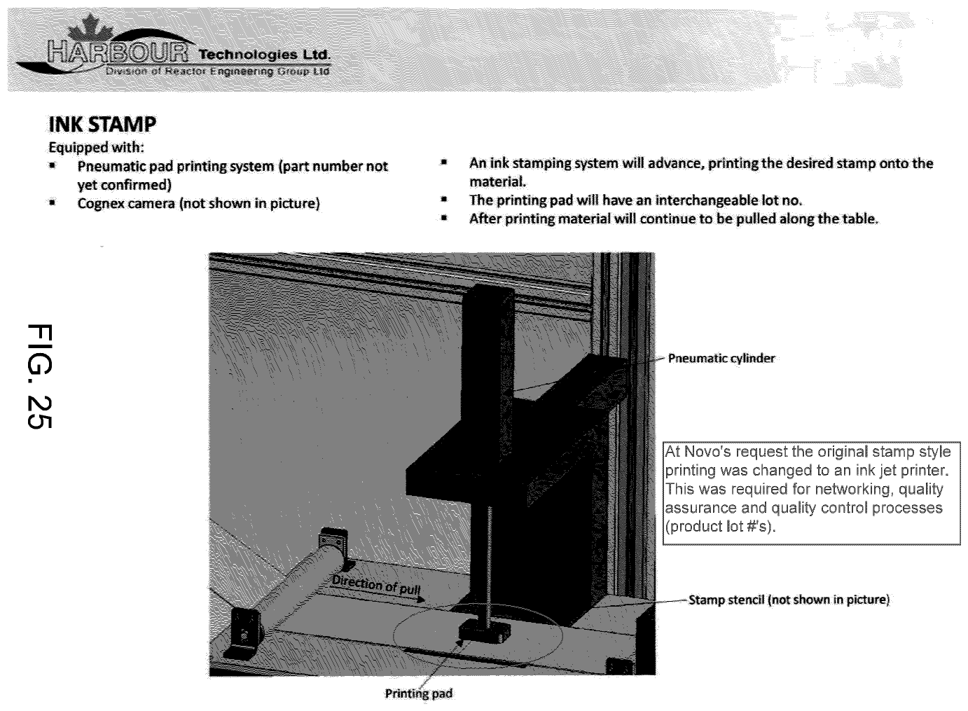

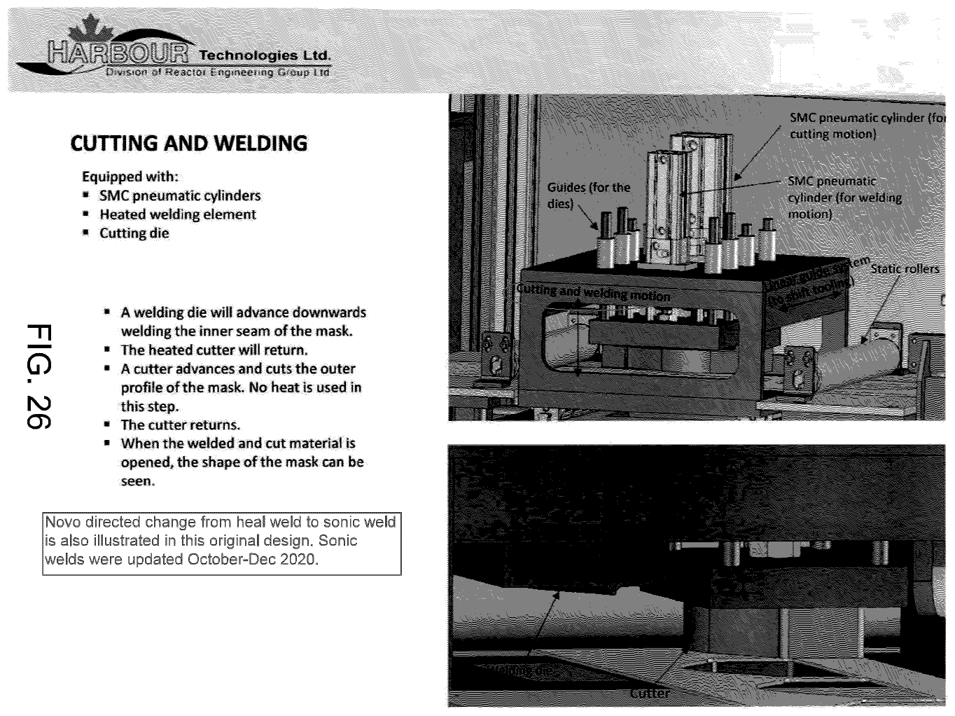

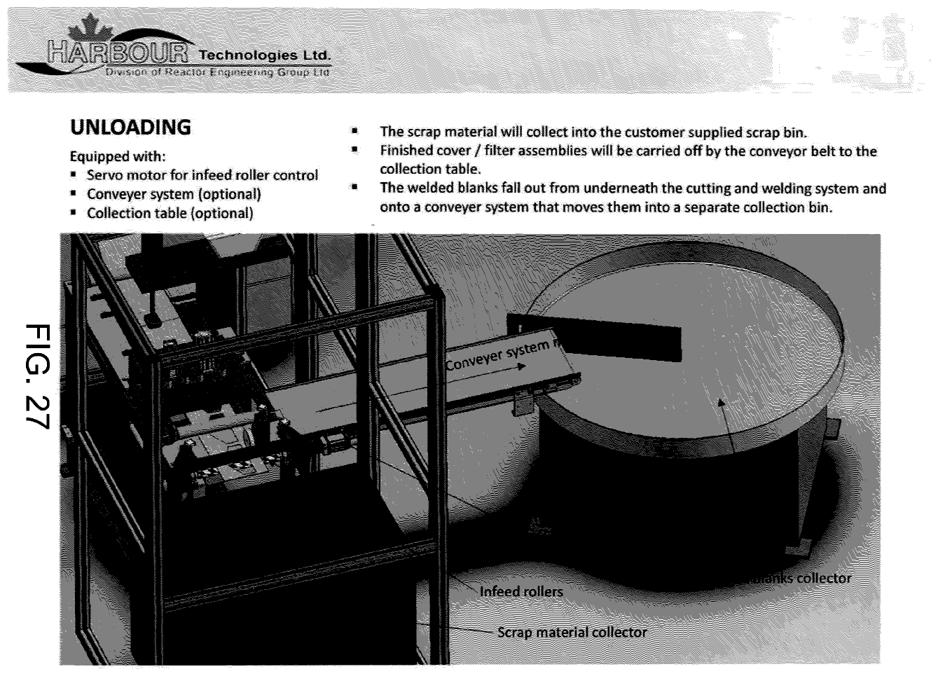

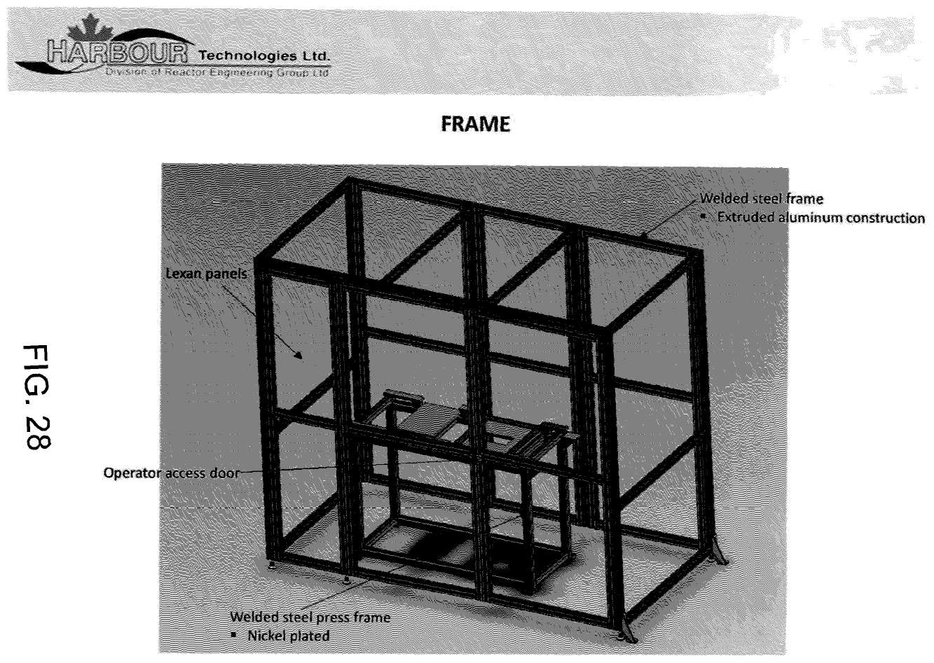

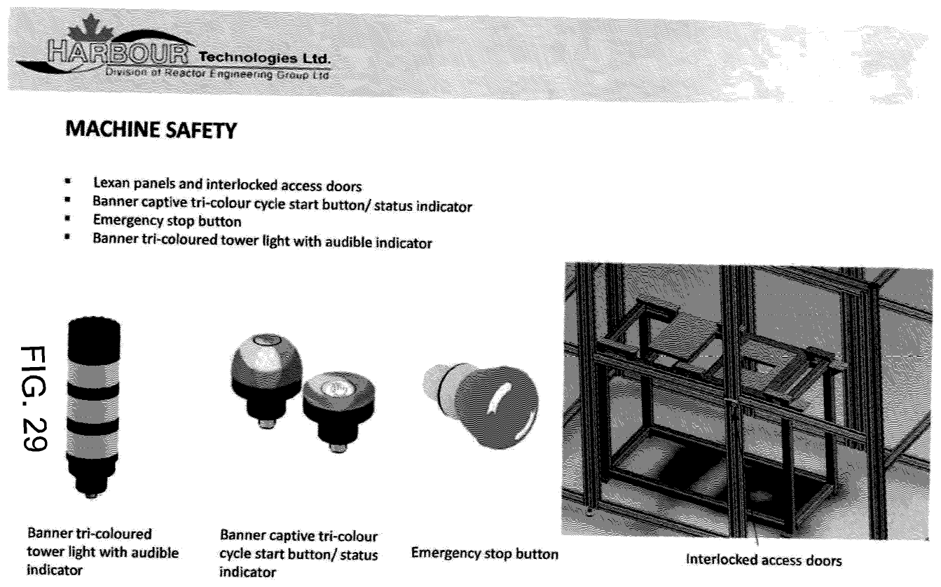

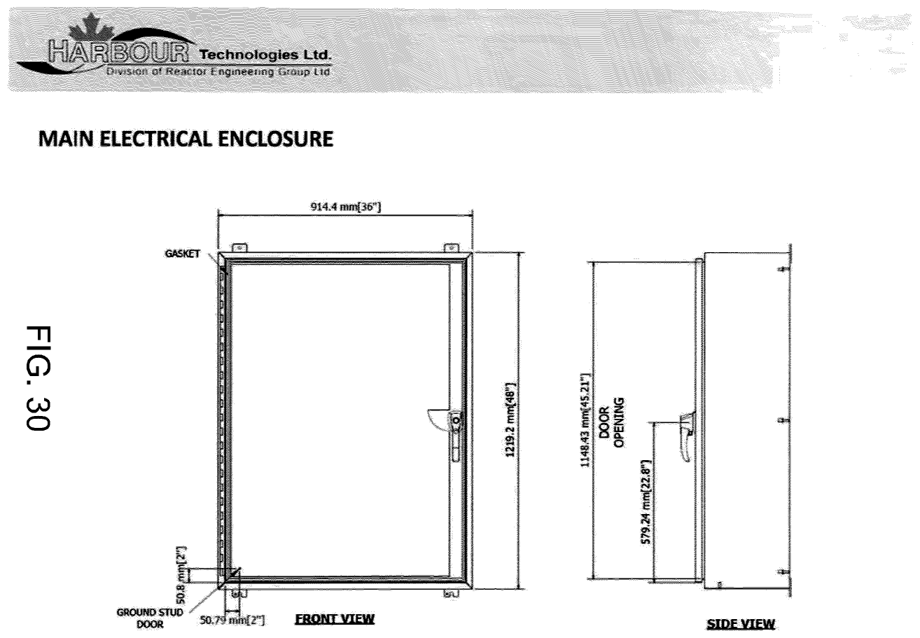

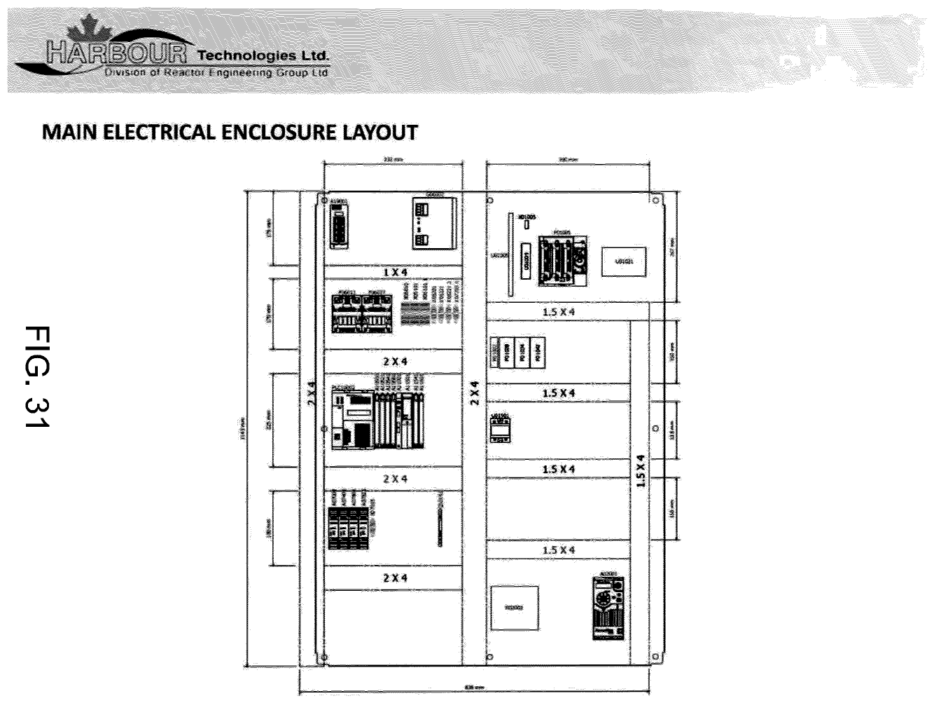

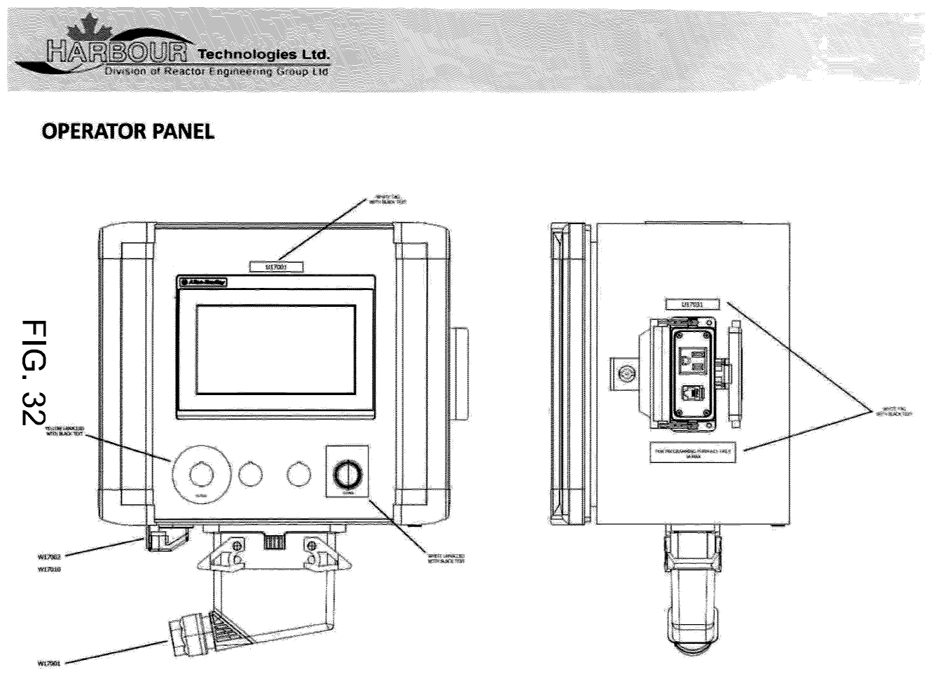

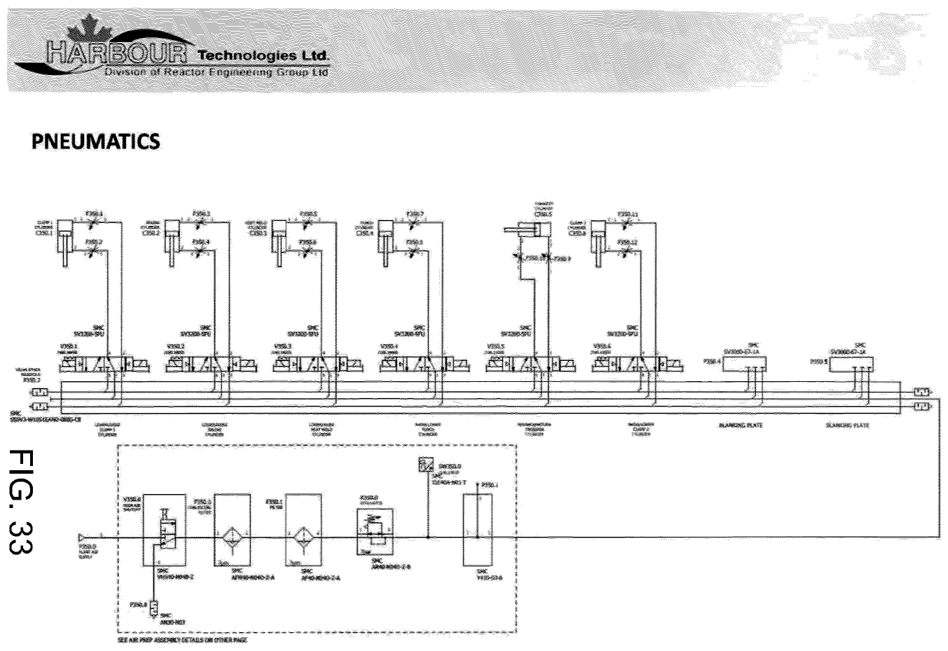

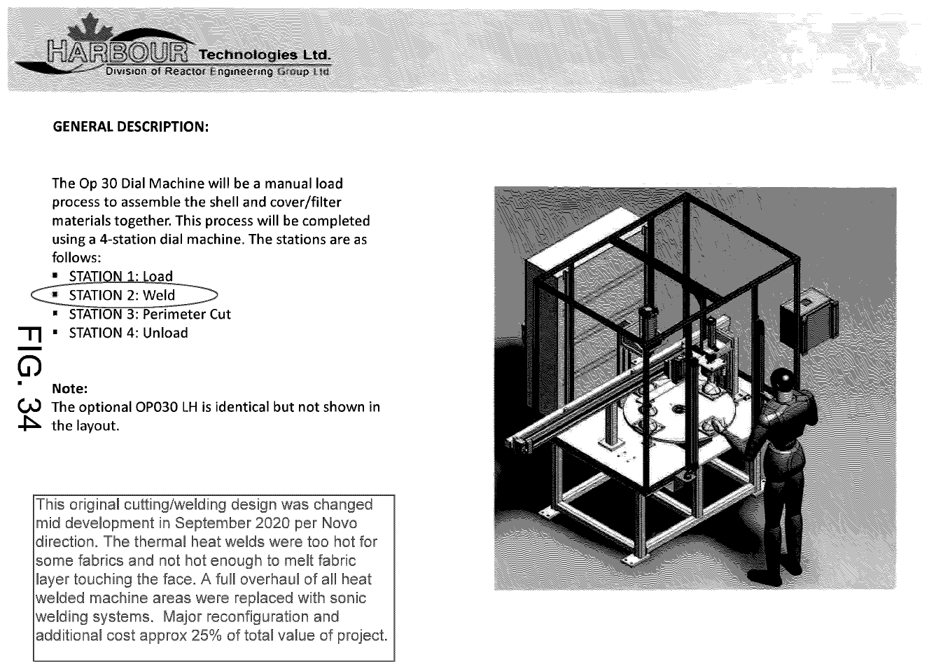

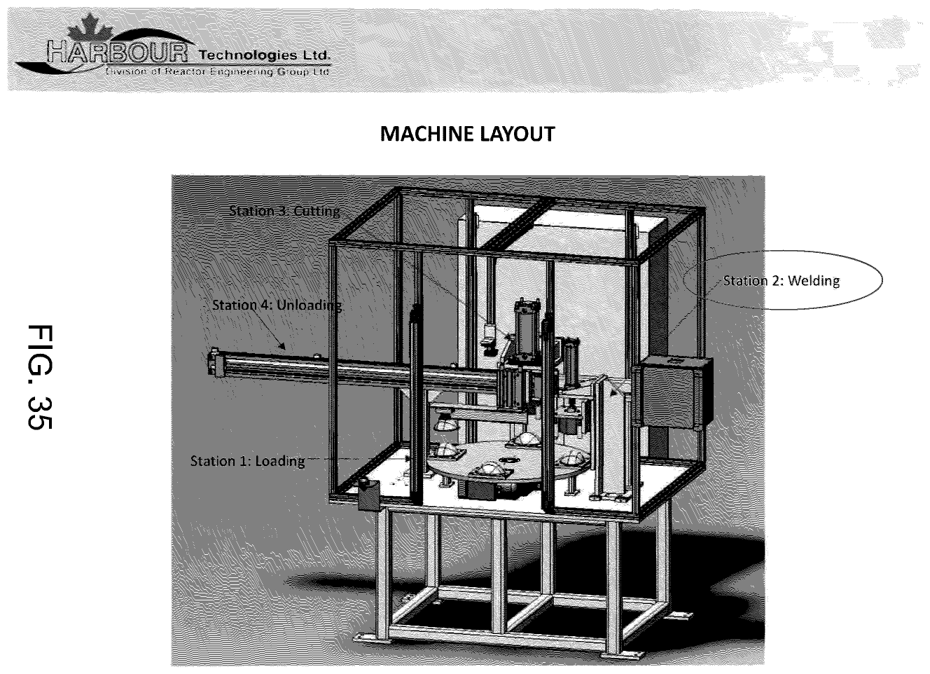

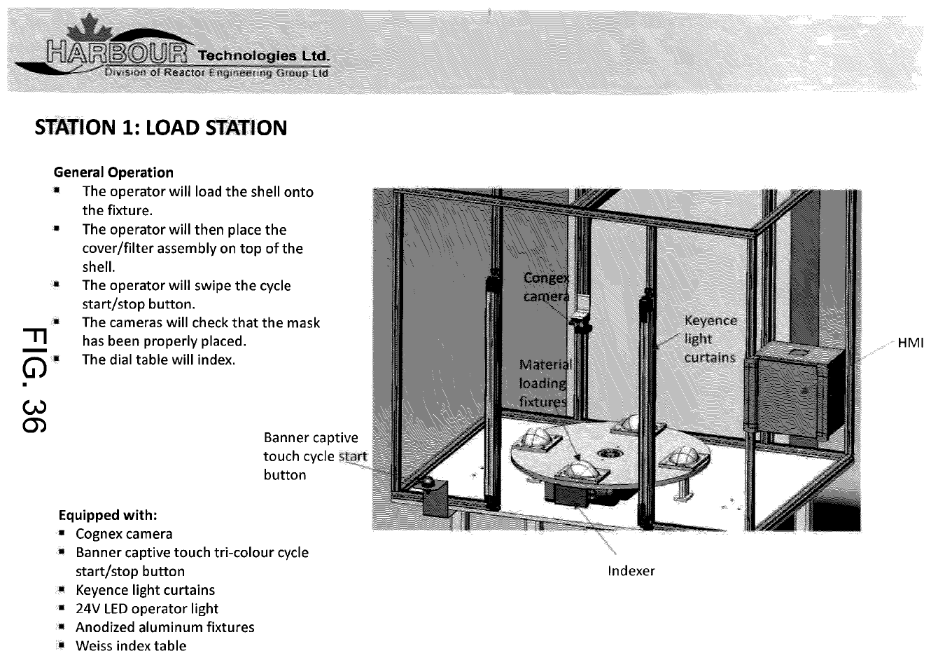

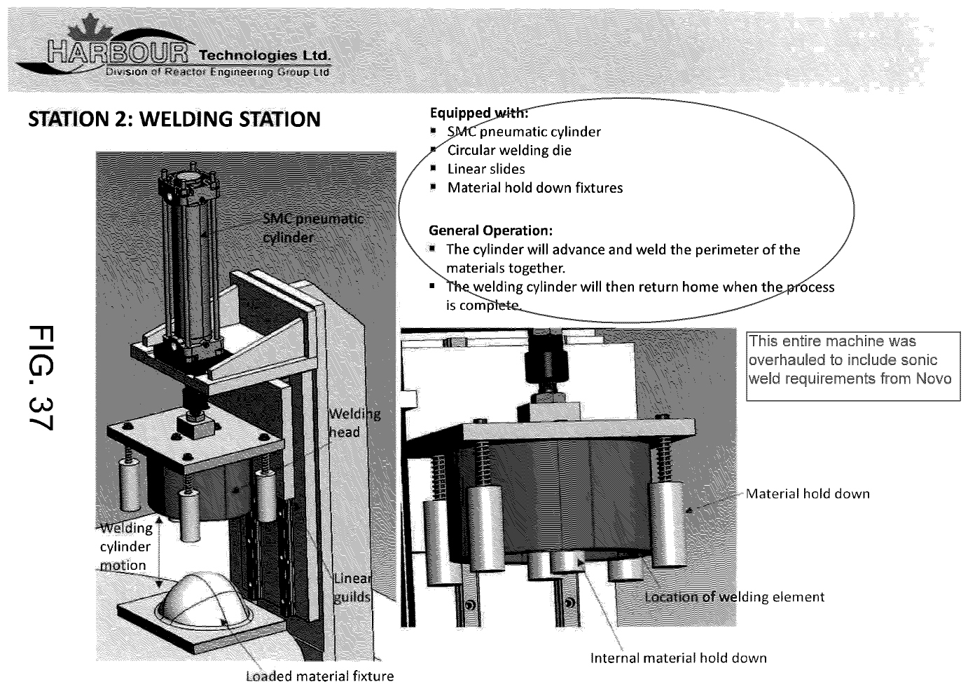

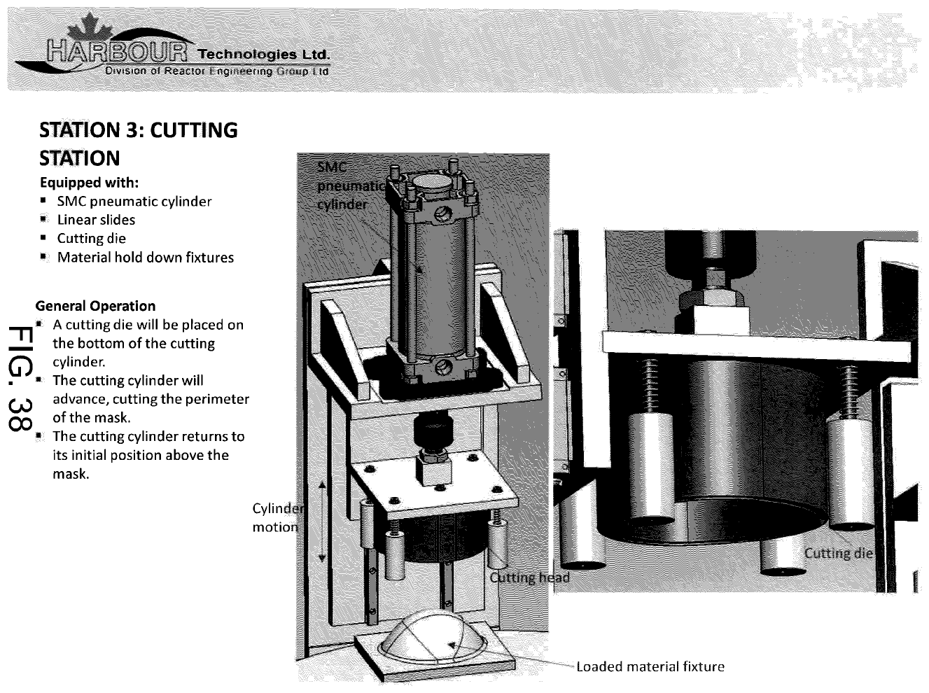

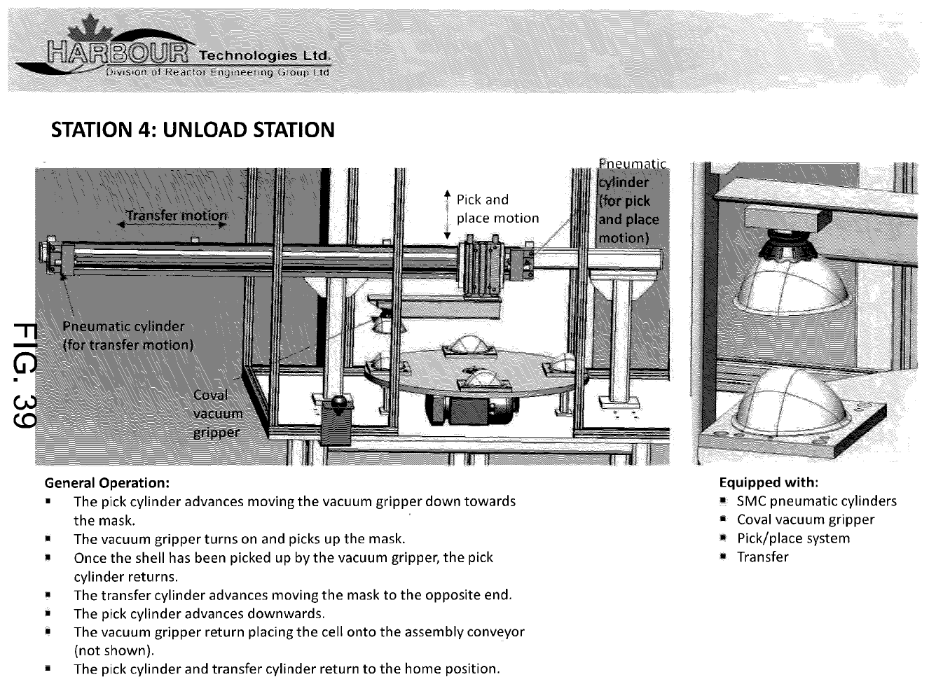

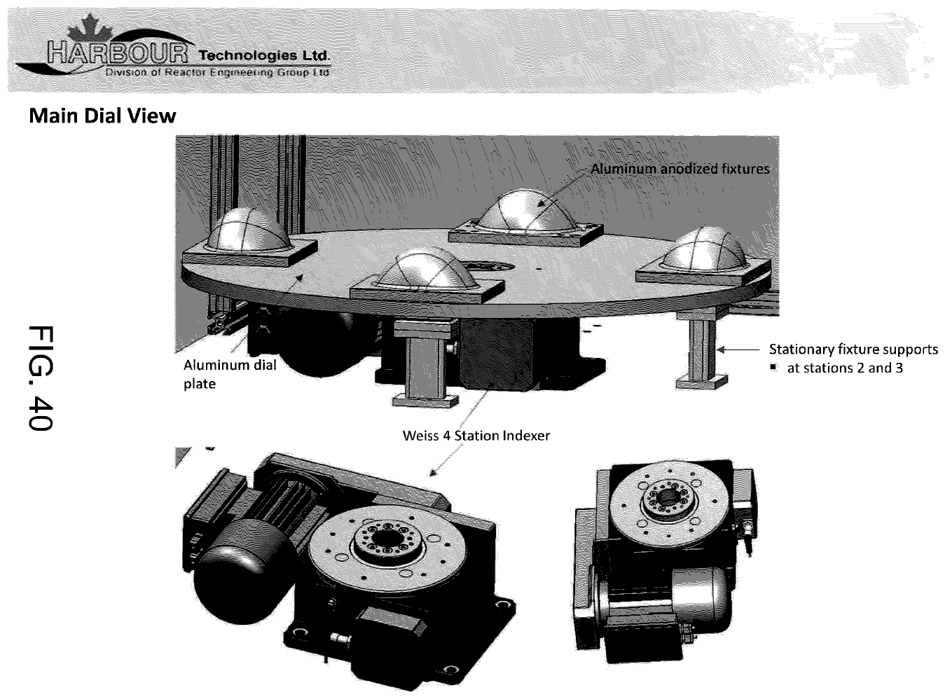

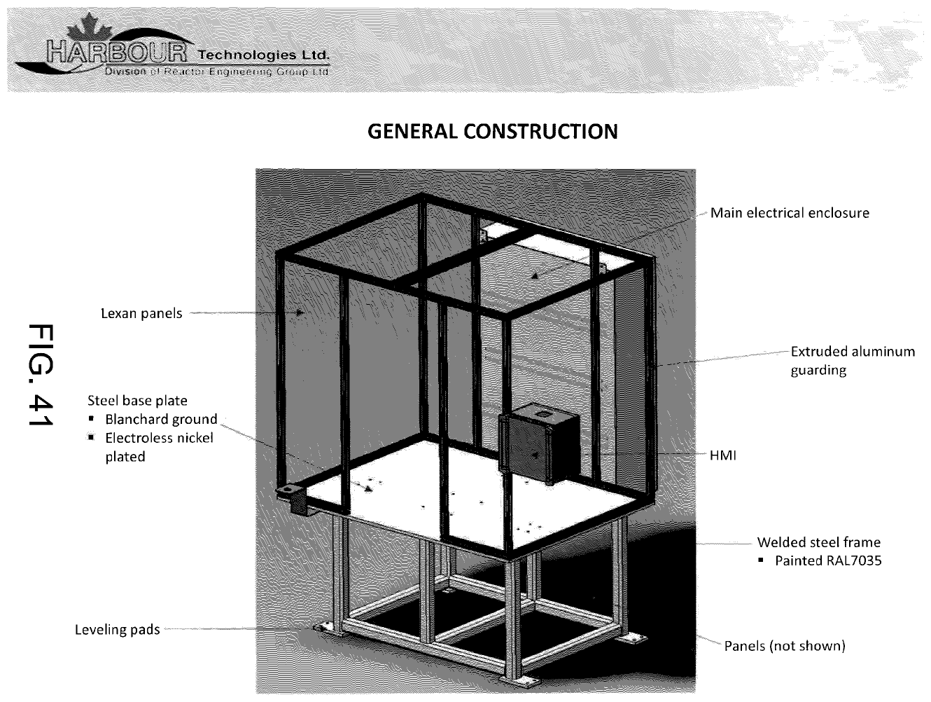

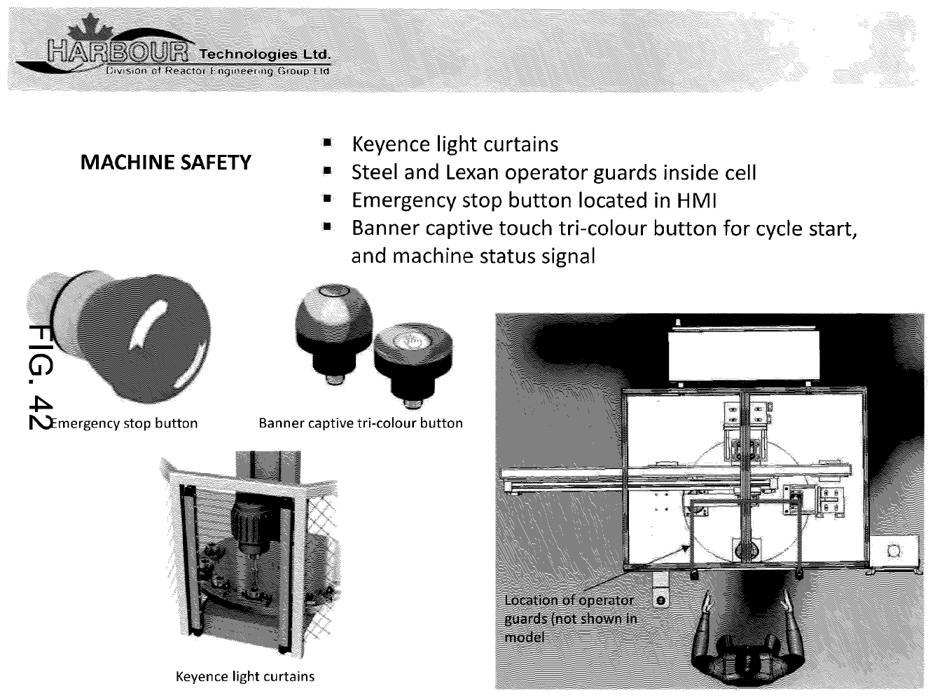

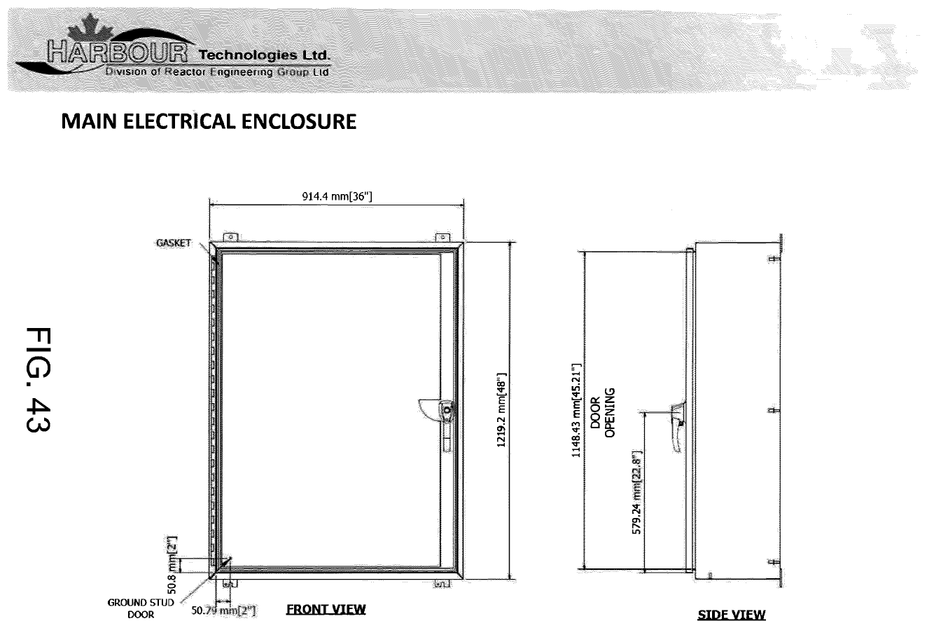

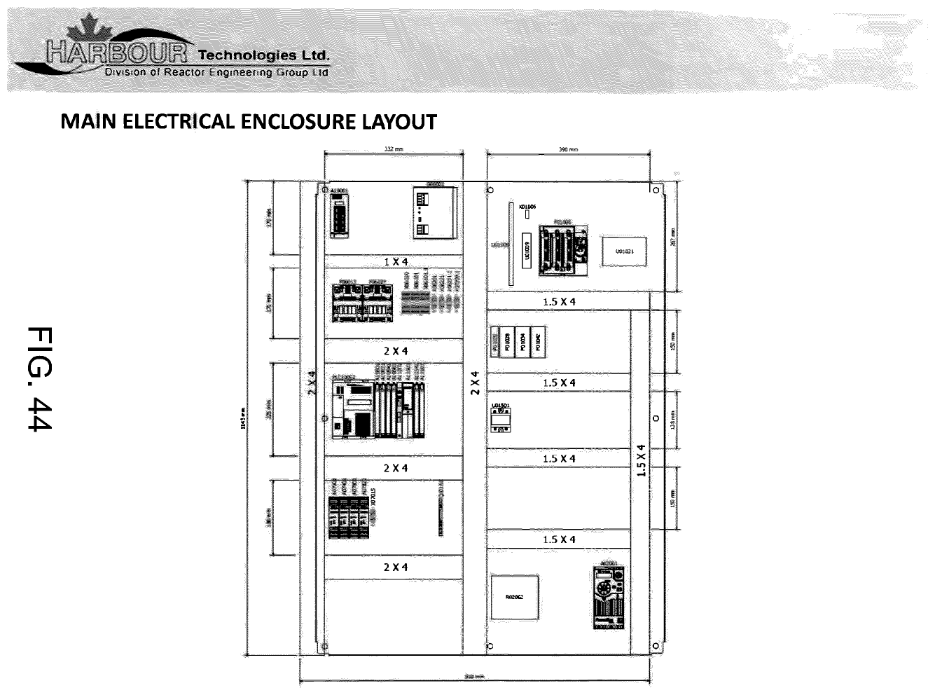

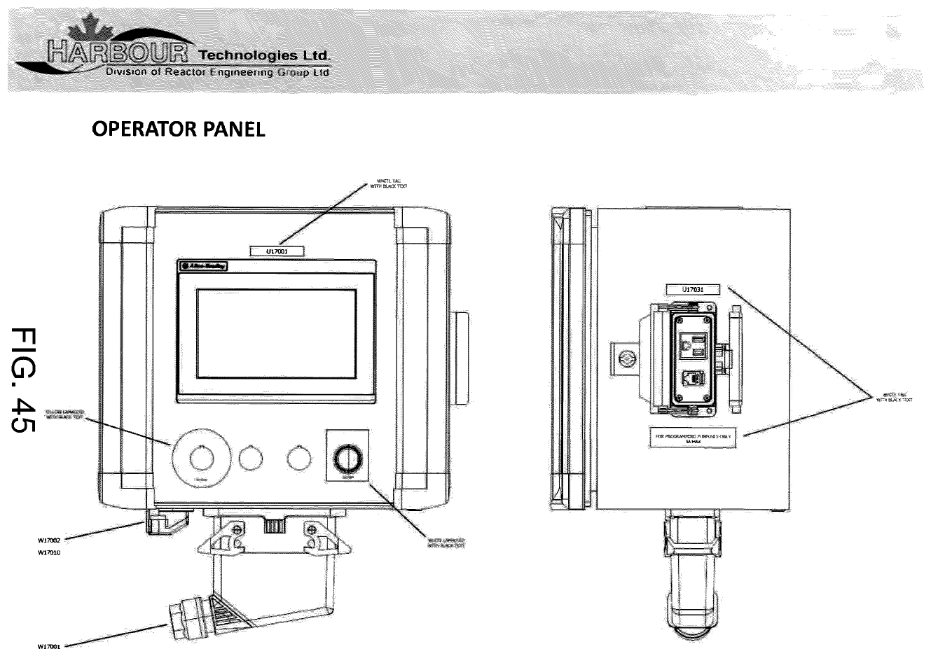

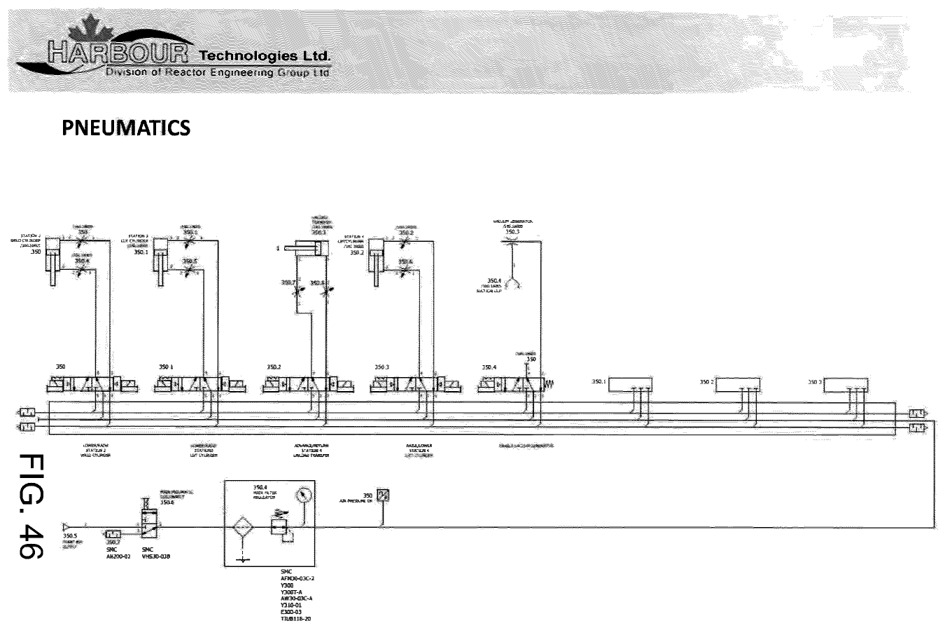

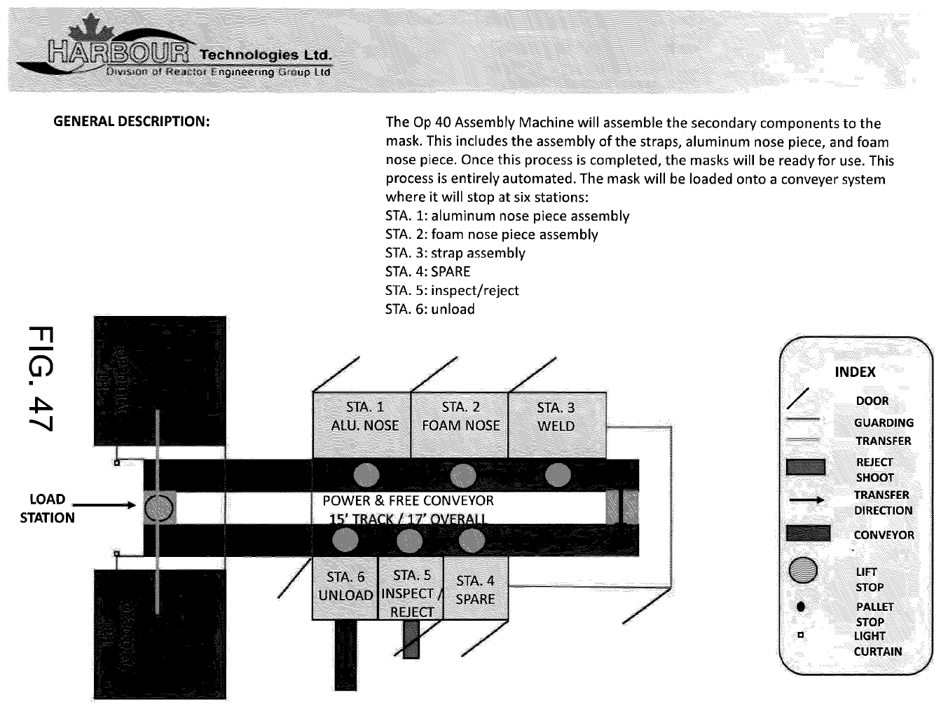

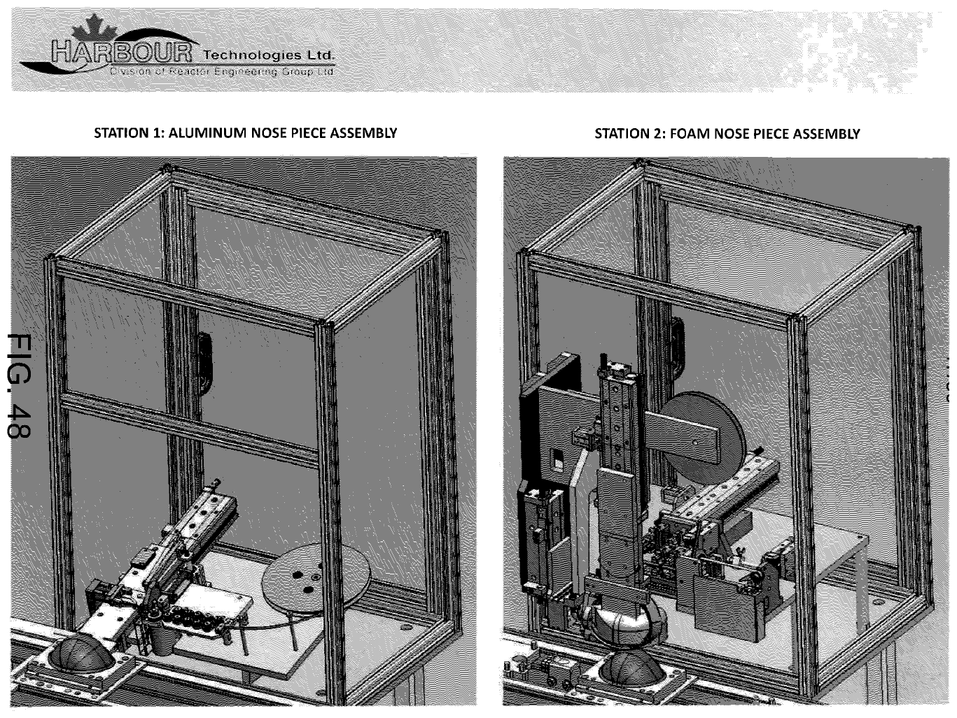

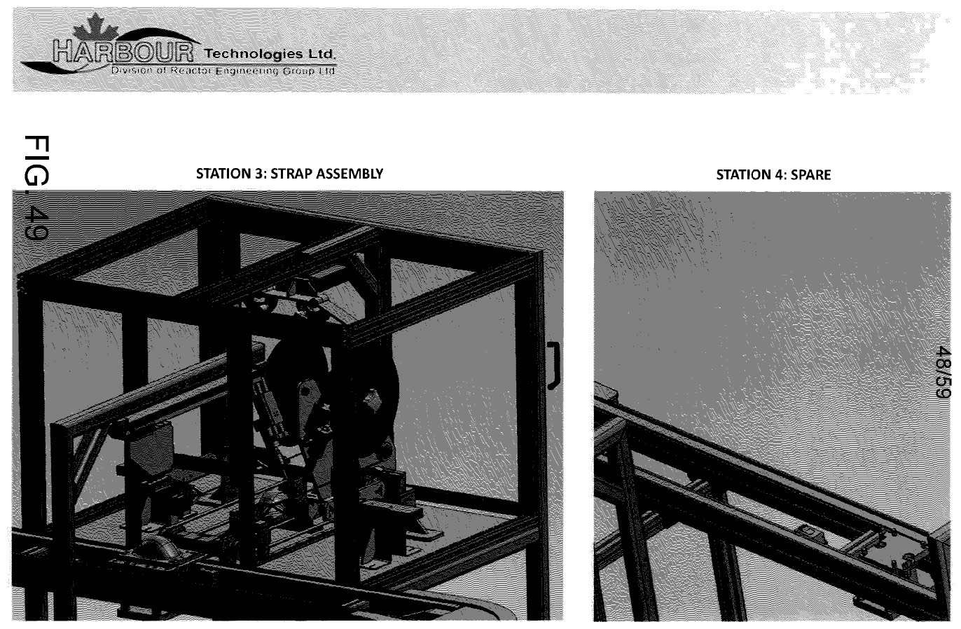

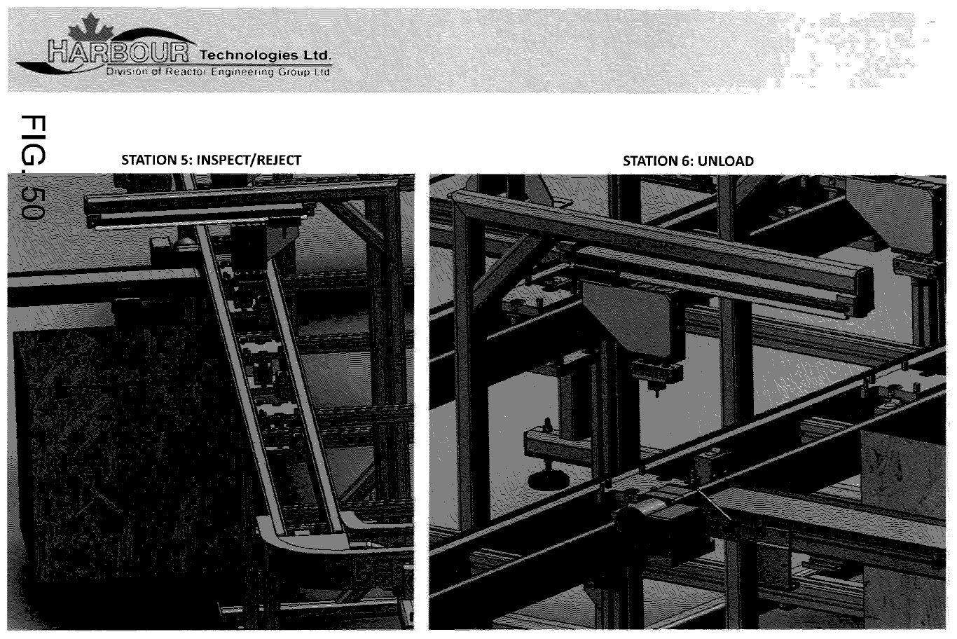

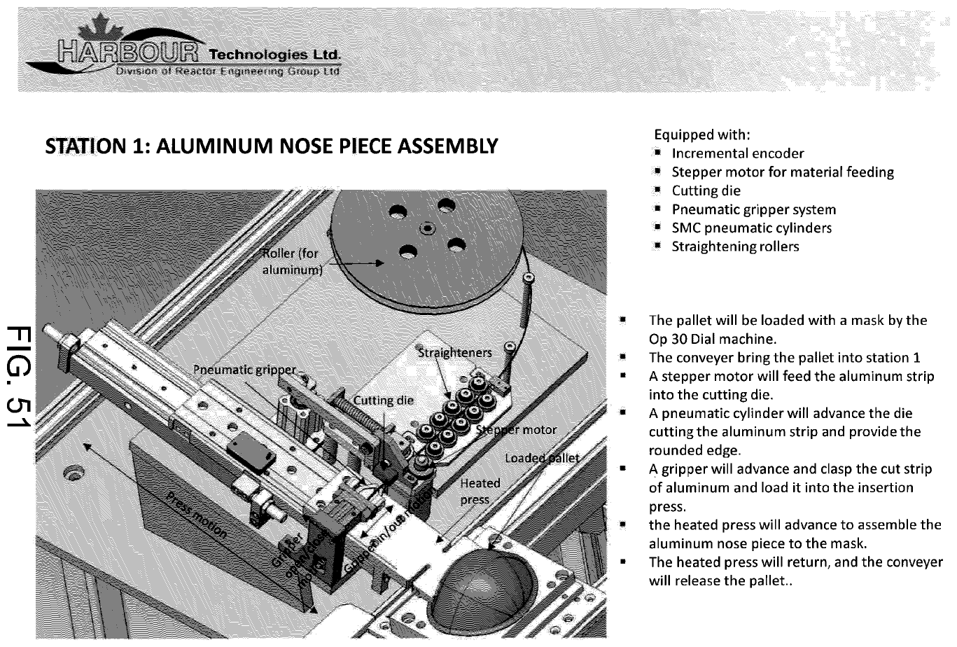

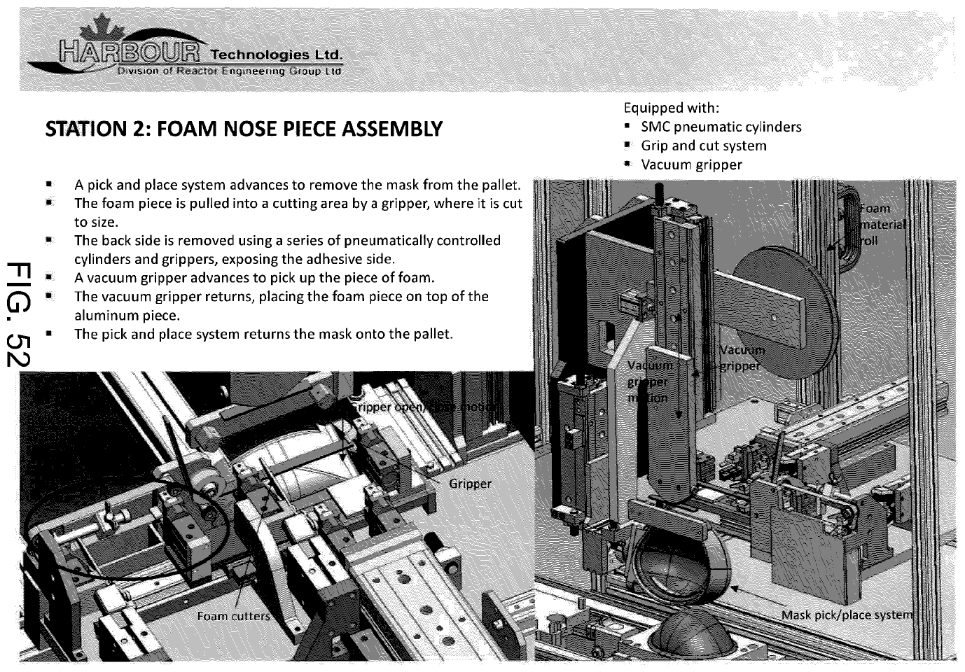

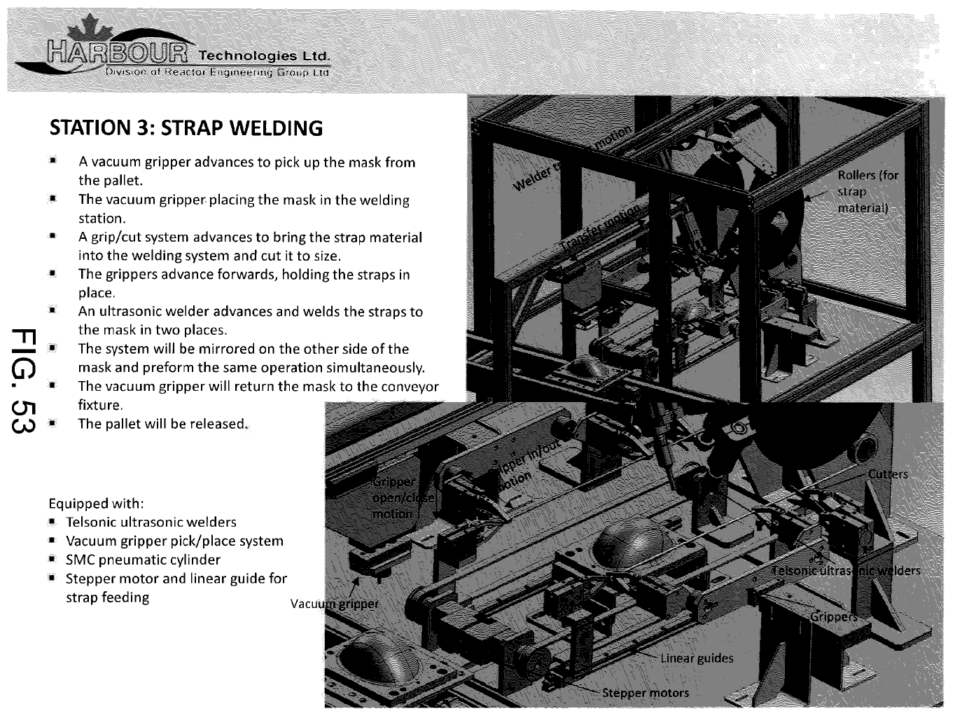

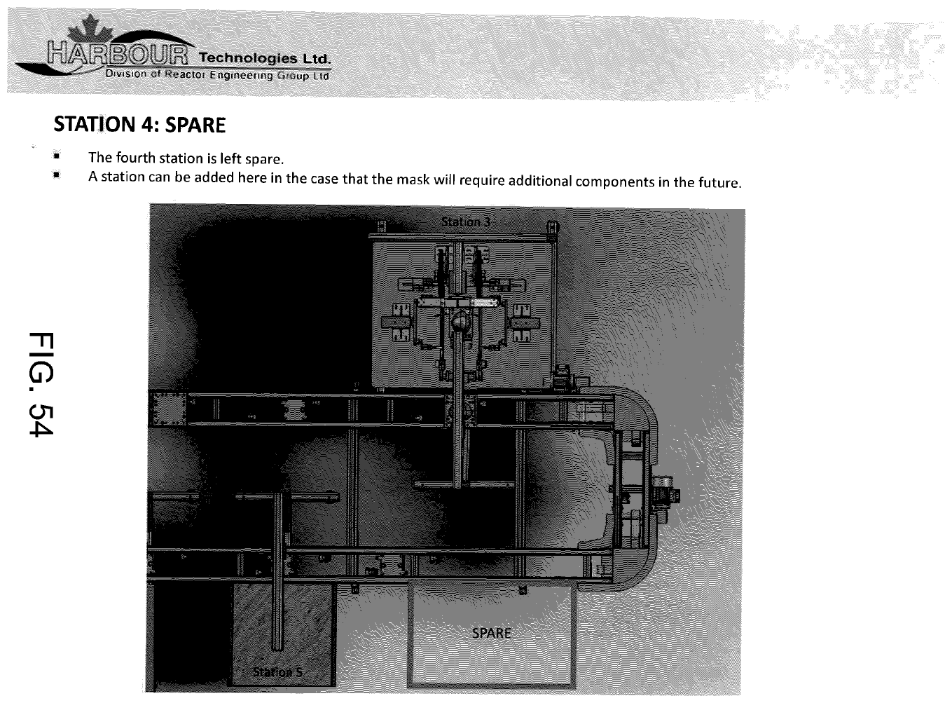

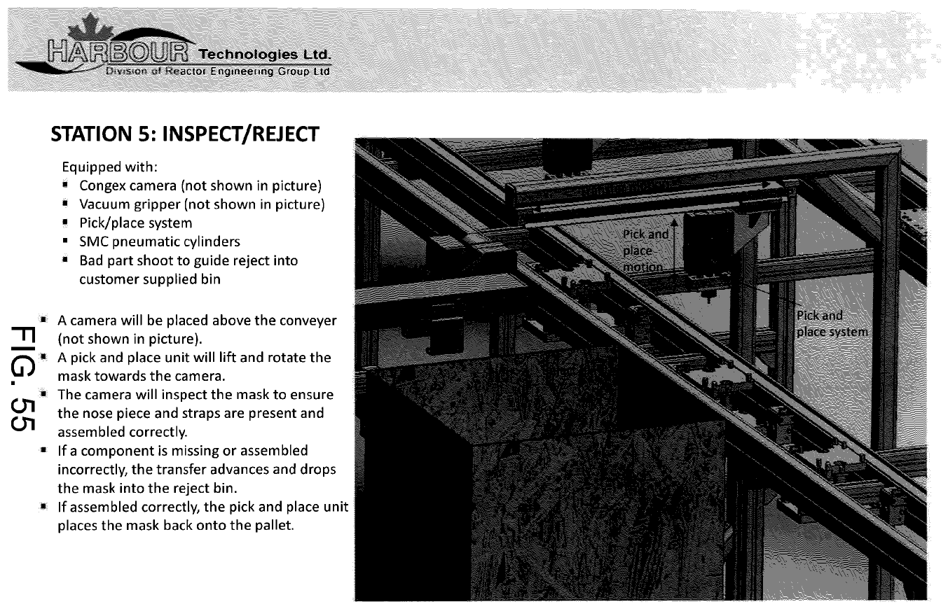

Referring now to FIG. 9, a method for manufacturing a cup-style filtering facepiece respirator is shown generally at 80. The method may include a molding step 800, a welding step 810, a combining step 820 and a fitting step 830.

The molding step 800 may involve forming an inner cup of the cup-style filtering facepiece respirator by heat molding a shaping layer and a hydrophilic contact layer to form a molded cup. In one embodiment, the molding step 800 may involve a first heating step 802, comprising heating the shaping layer through a heated first mold piece to optionally between 110° C. and 130° C., and preferably to between 115° C. and 120° C., specifically 117.5° C. The molding step 800 may further involve a second heating step 804, comprising heating the hydrophilic contact layer through a complementary heated second mold piece to between 30 and 35° C. In some embodiments, the first 802 and second 804 heating steps may be done separately. In other embodiments, the first 802 and second 804 heating steps may be done concurrently. The molding step 800 may also involve a combining step 806, comprising combining the shaping layer and the hydrophilic contact layer by pressing the combining the shaping layer and the hydrophilic contact layer between the first and second mold pieces and applying pressure to form the inner cup.

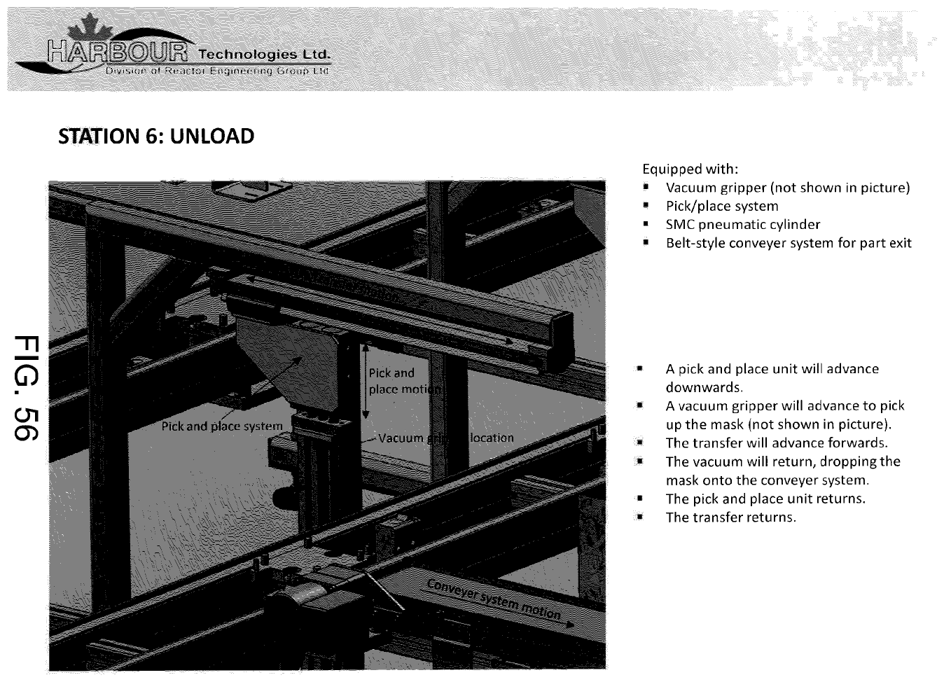

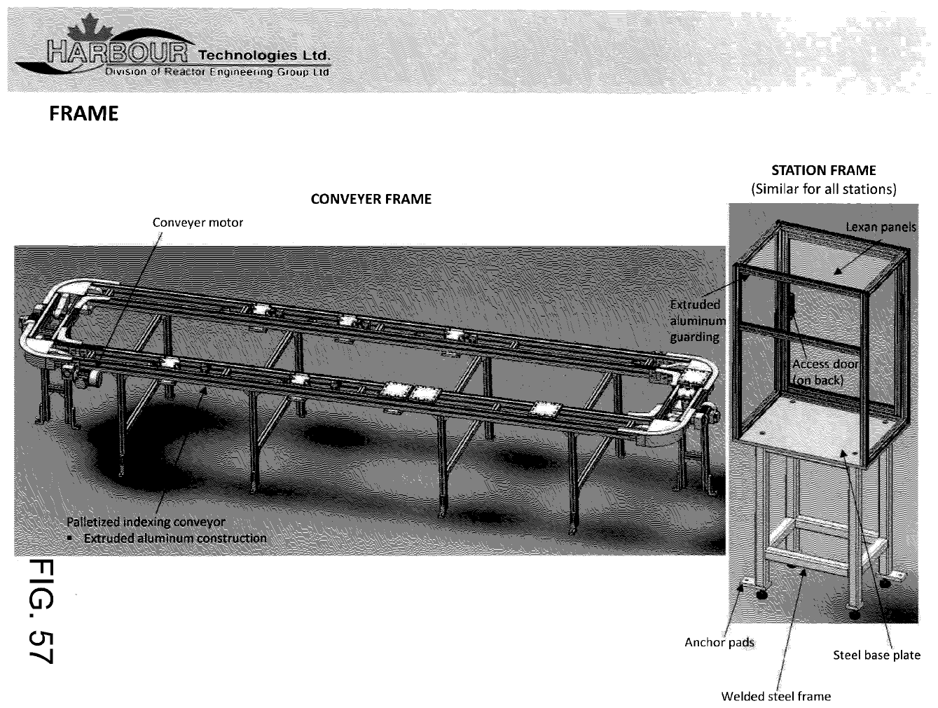

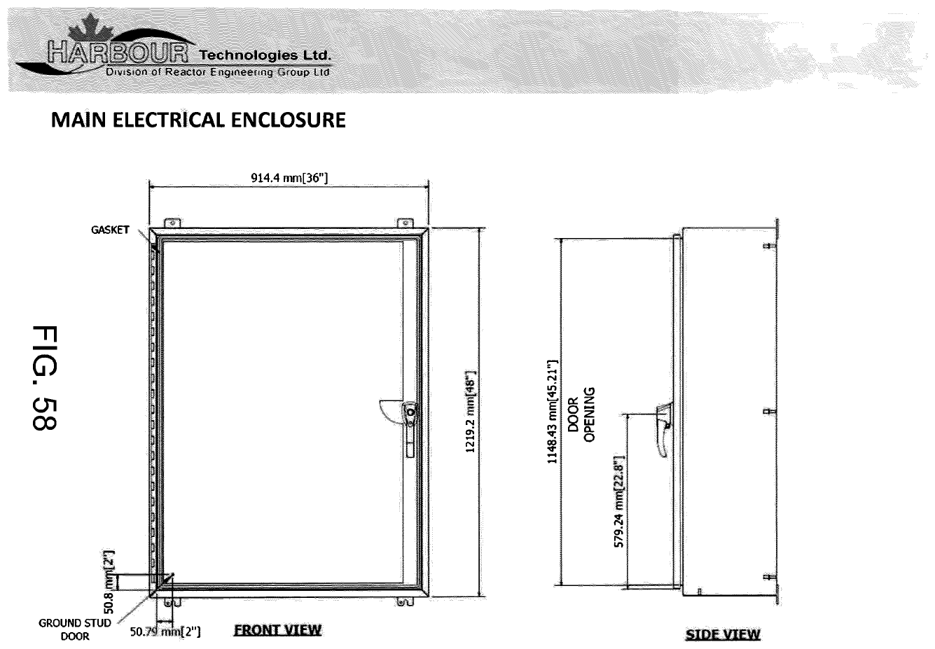

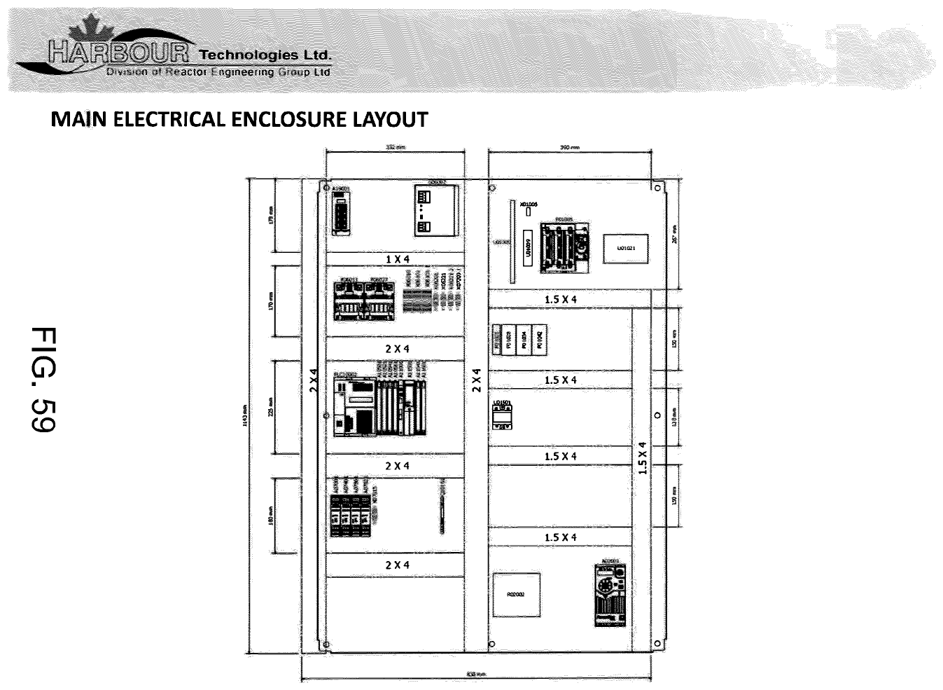

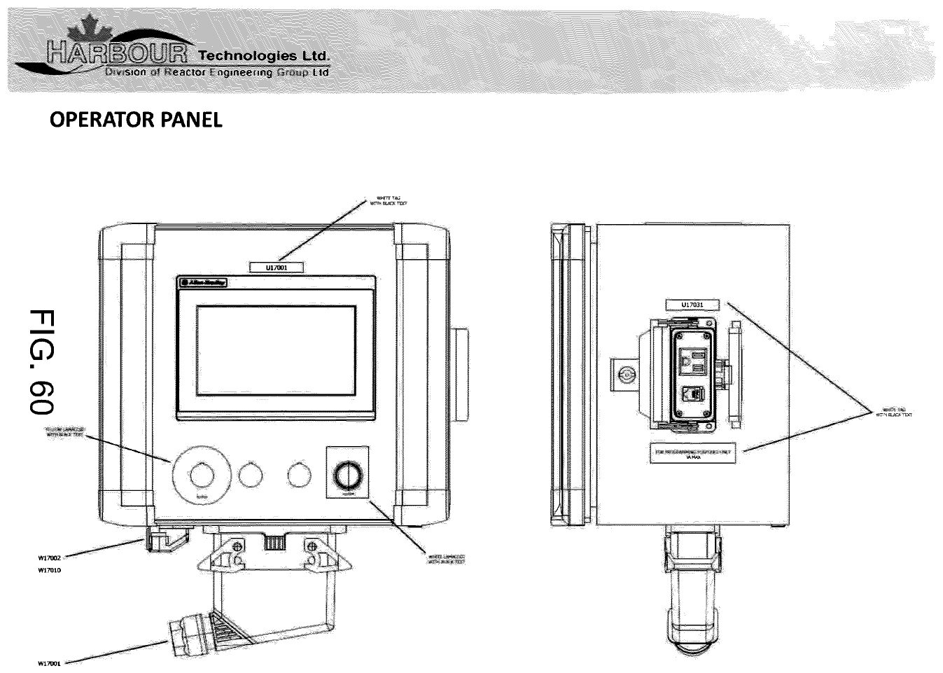

In one embodiment, the molding step 800 may be completed by a molding apparatus, as referenced in FIGS. 11-14 and FIGS. 18-21. In this embodiment, a roll of material may be placed onto the tensioning rack of the molding apparatus and the material may be fed to the apparatus by an operator or a pick and place load/unload system. Once the material is located between the first mold piece and the second mold piece, a signal may be sent to the apparatus either automatically or by the operator to begin the molding step. The first mold piece may then lower and may press the material into the second mold piece. Grippers of the apparatus may engage and clasp either side of the material that is being molded with sufficient force to avoid significant displacement or deformation of the materials during the molding step. In some embodiments, for instance as illustrated in FIGS. 11-14, heat may also be applied through the first mold piece and the second mold piece. Once the molding process is complete the first mold piece may return to the home position and the grippers may lift the molded material out of the second mold piece. A servo slide may advance, pulling new material into the mold area of the apparatus and ejecting the molded material. In some embodiments, for instance as illustrated in FIG. 15, the mold may comprise a riser, a common top plate, a spring, a heated first mold piece for applying heat and shaping material, a perforated edge for cutting at separating out the molded material, a hard stop, a location pad to collect material, a second mold piece for applying heat and shaping material, and a base plate for mounting. In some embodiments, for instance as illustrated in FIG. 16, the molding apparatus may include a pick and place load/unload system. The system may work to both unload and to pull material into the mold of the molding apparatus. The grippers may clasp or otherwise retain each side of the material while it is being molded. Once the molding process is complete the grippers may lift and the servo slide will advance pulling new material into the mold. The top mold may then lower, starting the molding cycle again. During the molding cycle the grippers may open, and the unloader may pull back, then return to the home position waiting for the mold to open. In some embodiments, for instance as illustrated in FIG. 17, the apparatus may have safety systems such as a light curtain, a light-up capacitive touch colored push button for cycle start, a plurality machine status signals, emergency stop buttons, and gate switches to permit access into guarded areas, for example.

The welding step 810 may involve forming an envelope by attaching a filtration layer and a hydrophobic layer at a seam. In embodiments, the envelope is formed by sonically welding the filtration layer and a hydrophobic layer. The welding step 810 may involve layering, in a layering step 812 the filtration layer and the hydrophobic layer such that the two layers of the filtration layer is located between the two layers hydrophobic layer. The welding step 810 may also involve welding, in a seam welding step 814 along a first edge of the filtration and hydrophobic layers to form a seam. The welding step 810 may also include an unfolding step 816 by separating the layers at an edge opposite the seam to form the envelope.

In one specific embodiment, for instance as illustrated in FIGS. 22, 23, 28, 30-33, the welding step 810 may be completed by a cutting and welding apparatus. The apparatus may assemble the fabric material layers and unroll the layers in a layering step 812 such that one hydrophobic layer is followed by two filter layers, then one more hydrophobic layer. A servo driven roller may then pull the layered material through the system at controlled indexes. Additional steps may be carried out by the cutting and welding apparatus, such as a stamping step which may print a logo onto the fabric, for example. The apparatus may then weld and cut the seam in the seam welding step 814 to form an assembly of welded fabric layers. A cylinder may then shift the tool and a die will cut out a shape from the assembly of welded fabric layers. Once the assembly is cut free, the cut free assembly may drop onto an exit conveyor and be carried to a collection table or a subsequent apparatus for further processing, such as the combining step 820, for example. In an embodiment, for instance as illustrated in FIG. 24, the apparatus may receive fabric layers from a rack, which may be loaded by an operator with the fabric layers to be welded by the apparatus. In some embodiments, the rack may comprise a plurality of tension rollers and may be a tensioner rack. In embodiments one or more of the plurality of tension rollers may include a friction enhancing surface in order to appropriately engage the material. In embodiments with the additional stamping step, for instance as illustrated in FIG. 25, the apparatus may include a printing device or stamping device such as an ink stamp, inkjet printer, stencil spray, or any other apparatus for printing on the material as it passes through the apparatus. In a particular embodiment, for instance as illustrated in FIG. 25, the printing device may be an inkjet printer to allow for variation such as by lot number, for example. The cutting and welding apparatus additionally comprises a welding device for attaching or combining layers of fabric. In some embodiments, the welding device may be a heated welding element, an ultrasonic welding element, a sewing system, a staple system, a glue system or any other means of attaching layers of fabric. The welding device may also comprise a cutter for separating excess material from the welded layers. The cutter may be heated or non-heated. In an embodiment, for instance as illustrated in FIG. 26, when the welded and cut material is opened, the shape of the mask can be seen. Excess material may be collected in a scrap bin, for example, for instance as illustrated in FIG. 27, while the cut and welded layers may be carried by a conveyor belt to a collection table or to a subsequent apparatus for further processing. Welded blanks may fall out from underneath the cutting and welding apparatus and onto a conveyer system that moves them into a separate collection bin. In some embodiments, for instance as illustrated in FIGS. 28 and 29, the apparatus may further have safety systems such as a light-up capacitive touch colored push button for cycle start, a tower light with audio indicator, a plurality of interlocking access doors to control access to the machinery, and emergency stop buttons, for example.

The combining step 820 may involve combining the inner cup and the envelope, the edge of the envelope opposite the seam being welded to a perimeter of the inner cup such that the filtration layer is adjacent to the shaping layer to combine the inner cup and envelope and form a filtering face respirator blank or precursor. In one embodiment, the combining step may be carried out by sonically welding the inner cup and the envelope. In one embodiment, for instance as illustrated in FIGS. 34, 35, 40, 41, and 43-46, the combining step 820 may be carried out by a combining apparatus such as a dial machine. The combining step 820 in this embodiment may be a manually-loaded process to assemble the inner cup and the envelope together using a 4-station dial machine having a loading station, a welding station, a perimeter cutting station, and an unloading station. At the loading station, an operator may load the inner cup onto a fixture, for instance as illustrated in FIG. 36. The operator may then place the envelope on top of the inner cup and press the cycle start/stop button. In embodiments, cameras may check alignment and placement of the envelope and inner cup on the fixture, and may then allow the dial table to advance if alignment and placement is satisfactory. At the welding station, a welding element may be brought into proximity of the envelope and inner cup to perform a weld. In a particular embodiment, the welding station may comprise a pneumatic cylinder attached to a welding head having a welding element, which may advance along linear slides towards the stacked envelope and inner cup in order to weld the perimeter of the envelope and inner cup together. In such an embodiment, for instance as illustrated in FIG. 37, the welding element may be a circular welding die, or a welding die shaped to correspond with the desired contour of the facepiece respirator, for example. A plurality of weighted material hold-down fixtures may apply force on the stacked upper and lower cups to prevent unwanted motion while the welding is occurring. In some embodiments, for instance as illustrated in FIG. 37, the welding die may be a heat welding die, or may be an ultrasonic welding tool. In embodiments, the envelope and inner cup are received within an oversized mold with respect to the size of the molded inner cup, and the weighted material hold-down fixture displaces the envelope and inner cup so that an inner edge is formed adjacent to the welded seam 670 of the respirator 60 on at least a portion of the circumference of the welded seam 670, when the welding is carried out. The pneumatic cylinder may then return the welding element to its initial position. At the perimeter cutting station, a cutting device may be brought into proximity of the welded envelope and inner cup to cut out a shape. In an exemplary embodiment, for instance as illustrated in FIG. 38, the perimeter cutting station may comprise a pneumatic cylinder attached to a cutting die, which may advance along linear slides towards the welded envelope and inner cup, cutting the perimeter of the facepiece respirator from the welded envelope and inner cup. In such an embodiment, the cutting die may be a circular cutting die, or a cutting die shaped to correspond with the desired contour of the facepiece respirator, for example. A plurality of weighted material hold-down fixtures may apply force on the stacked envelope and inner cup to prevent unwanted motion while the cutting is occurring. The pneumatic cylinder may then return the cutting die to its initial position. At the unloading station a manipulator may be moved down towards the respirator by a movement system, such as a movement system comprising a pair of pneumatic cylinders-a pick cylinder and a transfer cylinder—in an exemplary embodiment. In such an embodiment, for instance as illustrated in FIG. 39, the manipulator may then activate and pick up the respirator. Once the respirator has been picked up by the manipulator the pick cylinder may then return. The transfer cylinder may then advance, moving the respirator to the opposite end. The pick cylinder may then advance downwards, and the manipulator may place the respirator onto a assembly conveyor to move on to the fitting step 830. The pick cylinder and transfer cylinder may then return to their respective home positions. In some embodiments, the manipulator may be a vacuum gripper, or may be any other end effector for manipulating and carrying the respirator, such as mechanized forceps, for example. In some embodiments, for instance as illustrated in FIG. 42, the apparatus may further have safety systems such as a light-up capacitive touch colored push button for cycle start, light curtains, physical operator guards within the apparatus, and emergency stop buttons.

The fitting step 830 may involve a nosepiece fitting step 832, comprising fitting a nosepiece to the respirator. The fitting step 830 may also involve a strap fitting step 834, comprising attaching one or more straps, such as elastics for securing the respirator to a user's face, to the respirator. The fitting step 830 may additionally involve an inspection step 836 for quality assurance. In some embodiments, for instance as illustrated in FIGS. 47, and 57-60, the fitting step 830 may be carried out by a fitting apparatus. The fitting apparatus may be entirely automated comprising a conveyor system and a plurality of stations. In one embodiment, for instance as illustrated in FIGS. 48 and 51, the first station may be a nose piece fitting station for carrying out the nosepiece fitting step 832. At the nose piece fitting station, the nose piece wire may be fed from a roller having an incremental encoder and a stepper motor for incremental material feeding. In embodiments, the nose piece fitting station includes one or more nose piece wire feed guides through which the nose piece wire is fed. In embodiments, the nose piece fitting station may include one or more transducers for determining the length and presence of the feeding material. In a preferred embodiment, the transducer is a laser sensor. A respirator may arrive at the nose piece fitting station via conveyor, and the stepper motor may feed the aluminum strip into a cutting die of the nose piece fitting station. The die may then cut the aluminum strip. In one embodiment, this may comprise a pneumatic cylinder advancing the cutting die, for example. A gripper may then advance and clasp the cut strip of aluminum and load it into the insertion press to assemble the aluminum nose piece to the respirator. In one embodiment, the insertion press may be a heated press including a heating element and the aluminum wire may comprise an aluminum wire with a hot melt backing, such that the heated press attaches the aluminum wire to the respirator. In embodiments, the heated press may further include a temperature sensor located proximal to the heating element. In one embodiment, the heated press is heated to between 88° C. and 98° C., and optimally to between 92° C. and 94° C. for 3 seconds, and the aluminum wire is 0.6 mm thick. In an alternate embodiment, the heated press is heated to between 51° C. and 61° C., and optimally to between 55° C. and 57° C. for 15 seconds, and the aluminum wire is 1 mm thick. The heated press may then return, and the conveyor may carry the respirator to a subsequent station. In embodiments, an additional mask alignment step is carried out to align the mask on the conveyer prior to transporting it to the subsequent station. In some embodiments, the fitting step 830 may optionally include a foam nose piece fitting step, which may be carried out at a foam nose piece fitting station. In some embodiments, for instance as illustrated in FIGS. 48 and 52, a pick and place system may advance to remove the respirator from the conveyor. A foam piece may be pulled into a cutting area by a gripper, where it is cut to size. The back side of the foam piece may be removed using a series of pneumatically controlled cylinders and grippers, exposing an adhesive side. A vacuum gripper may then advance to pick up the piece of foam and the vacuum gripper may then return, placing the foam piece on top of the aluminum nosepiece. The pick and place system returns the respirator onto the conveyor to carry the respirator to a subsequent station. In one embodiment, for instance as illustrated in FIGS. 49 and 53, the strap fitting step may be carried out by a strap fitting station of the fitting apparatus. In such an embodiment, a manipulator, such as a vacuum gripper, may pick up the respirator from the conveyor. An attachment device may then advance and attach the straps to the respirator. The manipulator may then place the respirator into the fitting station. A grip/cut system may then advance, bringing strap material into the fitting system. In some embodiments, the attachment device may be a welding system, such as an ultrasonic welding system, and the strap material may be elastic polymer straps, for example. In such an embodiment, the attachment device may be an ultrasonic welder and the elastic straps may be welded onto the respirator by ultrasonically heating localized portions of the strap to fuse it with the respirator material. The fitting system may then repeat a similar process for additional straps and for the opposite side of the respirator to form a symmetric set of straps. The manipulator may then return the respirator to the conveyor, and the conveyor may carry the respirator to a subsequent station. In some embodiments, for instance as illustrated in FIGS. 49 and 54, the fitting apparatus may have one or more spare stations for future expansion, such as for if the respirator requires additional components in the future, for example. If any step of the fitting step is not necessary, such as the foam nose piece fitting step, for example, the associated station may also be vacated to become an additional spare station.

In one embodiment, for instance as illustrated in FIGS. 50 and 55, the inspection step 836 may be carried out by an inspect/reject station of the fitting apparatus. The inspect/reject station may comprise a manipulator, a camera, and a plurality of movement systems. In some embodiments, the manipulator may be a vacuum gripper, the camera may be an optical camera, and the movement systems may be pneumatic cylinders, for example. The camera may be located above the conveyor, and the manipulator may engage with, lift, and rotate the respirator as it travels through the inspect/reject station along the conveyor. The camera may inspect the respirator to ensure that the nose piece and straps are present and assembled according to predetermined specifications. If a component is missing or improperly assembled, movement systems may move the manipulator to deposit the respirator at a rejection site. If the respirator is adequately assembled, the manipulator may return the respirator to the conveyor to be carried to a subsequent station or output.

In some embodiments, for instance as illustrated in FIGS. 50 and 56, the fitting apparatus may also comprise an unloading device, which may comprise a plurality of movement systems for one or more manipulators. In some embodiments, the manipulators may be end effectors such as vacuum grippers, and the movement systems may be pneumatic cylinders. The manipulators may move the completed respirator from the conveyor onto another conveyor for carrying the respirator away from the fitting apparatus, or to any other output location.

While the foregoing is directed to aspects of the present disclosure, other and further aspects of the disclosure can be devised without departing from the basic scope thereof.

What is claimed is:

1. A filtering face respirator, the filtering face respirator comprising:
at least one inner cup;
at least one envelope abutting and overlapping with the cup;
a formed nose interfacing portion; and
at least one strap attached to the face respirator, and
wherein at least one of the envelope or the inner cup are formed.

2. The filtering face respirator of claim 1, wherein the envelope comprises a hydrophobic fabric.

3. The filtering face respirator of claim 2, wherein the hydrophobic fabric is selected from the group consisting of: polypropylene, linen, polyurethane, polyester, and polyamide.

4. The filtering face respirator of claim 1, wherein the inner cup comprises a hydrophilic fabric.

5. The filtering face respirator of claim 4, wherein the hydrophilic fabric is selected from the group consisting of: cotton, polypropylene, linen, polyurethane, polyester, and polyamide.

6. The filtering face respirator of claim 1, wherein the envelope comprises three layers which are sonically welded together to form the envelope.

7. The filtering face respirator of claim 6, wherein one or more layers of the three layers comprises a hydrophobic fabric and one or more layers of the three layers comprises a hydrophilic fabric.

8. The filtering face respirator of claim 1, wherein the inner cup comprises:
a shape layer for structurally shaping the inner cup; and
a contact layer for receiving contact with a user's face;
wherein the contact layer and the shape layer are heat molded to form the inner cup.

9. The filtering face respirator of claim 8, wherein the contact layer comprises a hydrophilic fabric.

10. The filtering face respirator of claim 8, wherein the shape layer is heated to between 110° C. and 125° C.

11. The filtering face respirator of claim 10, wherein the shape layer is heated to between 115° C. and 120° C.

12. The filtering face respirator of claim 11, wherein the shape layer is heated to 117.5° C.

13. The filtering face respirator of claim 8, wherein the contact layer is heated to between 30° C. and 35° C.

14. The filtering face respirator of claim 9, wherein the envelope comprises two layers which are sonically welded together to form the envelope, wherein an outermost layer of the two layers is a hydrophobic layer.

15. The filtering face respirator of claim 1, wherein the envelope and the inner cup are sonically welded together.

16. A method of manufacturing a filtering face respirator comprising:
forming at least one inner cup by molding a shaping layer and a hydrophilic contact layer;
forming an envelope by providing a filtration layer and a hydrophobic layer; and
combining, the inner cup and envelope at a base such that the filtration layer is adjacent to the shaping layer to form the filtering face respirator.

17. The method of claim 16, wherein molding the shaping layer and the hydrophilic contact layer comprises heating the shaping layer to between 110° C. and 125° C.

18. The method of claim 17, wherein molding comprises heating the shaping layer to between 115° C. and 120° C.

19. The method of claim 17 wherein molding comprises heating the shaping layer to 117.5° C.

20. The method of claim 16, wherein molding the shaping layer and the hydrophilic filtration layer further comprises heating the hydrophilic contact layer to about 30-35° C.

21. The method of claim 16, wherein providing the filtration layer and the hydrophobic layer comprises sonically welding the filtration layer and the hydrophobic layer at an edge to form a seam.

22. The method of claim 16, wherein combining comprises sonically welding the inner cup and the envelope at the base.

23. An apparatus for manufacturing a filtering face respirator comprising
a molding station comprising a first plurality of heated molds, a second plurality of molds that engage the first plurality of heated molds, and configured to receive one or more heat-moldable materials therebetween, for forming an inner cup;
a welding station comprising a first welding device and a first cutting device for forming an envelope;
a combining station comprising a second welding device, a second cutting device, and a mold for receiving at least one inner cup and at least one envelope and combining said at least one inner cup and at least one envelope; and
a fitting station comprising a nose piece fitting device and a strap fitting device,
wherein the apparatus is further configured to
form at least one inner cup by molding a shaping layer and a hydrophilic contact layer at the molding station;
form an envelope by providing a filtration layer and a hydrophobic layer; and
combine the inner cup and envelope at a base such that the filtration layer is adjacent to the shaping layer to form the filtering face respirator.
